(19) United States
(12) Patent Application Publication
(10) Pub. No.: US 2018/0205907 A1
(43) Pub. Date: Jul. 19, 2018

(54) REGISTRATION APPARATUS THAT REGISTERS REGISTRATION TARGET APPARATUS AND METHOD THEREOF

(71) Applicant: JVC KENWOOD Corporation, Yokohama-shi (JP)

(72) Inventors: Tatsuo Terajima, Yokohama-shi (JP); Yoshihito Kawabata, Yokohama-shi (JP); Yasutoshi Sakai, Yokohama-shi (JP)

(21) Appl. No.: 15/872,098

(22) Filed: Jan. 16, 2018

(30) Foreign Application Priority Data
Jan. 16, 2017 (JP) 2017-004812
Sep. 26, 2017 (JP) 2017-185014

(51) Int. Cl. H04N 5/77; H04N 21/426; H04N 21/41; H04N 21/442; H04N 21/4335; H04N 21/433; H04N 21/4223

(52) U.S. Cl. CPC H04N 5/77; H04N 21/42684; H04N 21/4135; H04N 21/4223; H04N 21/44231; H04N 21/4335; H04N 21/4334; H04N 21/44227

(57) ABSTRACT

A first recorder can be connected to a network. A recorder information acquisition unit acquires state information of a second recorder connected to the network. In a case where the second recorder is in a normal state, a camera information setting unit registers any of unregistered first to third cameras to the second recorder being in the normal state within a range of the settable number of ordinary channels on the basis of the acquired state information. In a case where the second recorder is in an abnormal state, the camera information setting unit substitutively registers any of the first to third cameras registered to the second recorder even in a range of the number of substitute channels.

### CROSS-REFERENCE TO RELATED APPLICATION

This application is based upon and claims the benefit of priority from the prior Japanese Patent Application No. 2017-004812, filed on Jan. 16, 2017 and Japanese Patent Application No. 2017-185014, filed on Sep. 26, 2017, the entire contents of which are incorporated herein by reference.

### BACKGROUND

### 1. Field

The present invention relates to a registration technique, and more particularly to a registration apparatus and method for registering a registration target apparatus connected to a network or a matrix switch.

### 2. Description of the Related Art

In a digital image monitoring system, images photographed by a monitoring camera are transmitted over a network and intensively monitored and recorded in a security room, or the like. In such a system, it is desirable to continue recording operation of the monitored image at the occurrence of a failure without preparing a spare recorder. To achieve this, a monitoring controller periodically checks an operation state of the recorder, and in a case where any of the recorders fails, records in a camera managed by the recorder that is not confirmed to be normal would be managed by another recorder operating normally (refer to Patent Document 1, for example).

### CITATION LIST

### Patent Document

[Patent Document 1] JP 2007-235914 A.

By detecting, by the monitoring controller, a failure and changing the apparatus in charge of camera recording, the image recording operation can be continued at an occurrence of a failure without preparation of a spare recorder. This, however, would necessitate addition of a monitoring controller, complicating the system configuration.

### SUMMARY

In order to solve the above-described problem, a registration apparatus according to an aspect of the present embodiment is a registration apparatus connectable to a network, the apparatus including: an acquisition unit that acquires state information of another registration apparatus connected to the network; and a registration unit that registers an unregistered registration target apparatus within a range of the settable number of ordinary channels, on the basis of the state information acquired by the acquisition unit. In a case where another registration apparatus is in an abnormal state, the registration unit substitutively registers a registration target apparatus registered to the other registration apparatus being in the abnormal state, even in a range of the number of substitute channels other than the ordinary channels.

Another aspect of the present embodiment is a registration method. A registration method in a registration apparatus connectable to a network, the method including: acquiring state information of another registration apparatus connected to the network; registering an unregistered registration target apparatus within a range of the settable number of ordinary channels, on the basis of the acquired state information; and in a case where the other registration apparatus is in an abnormal state, substitutively registering a registration target apparatus registered to the other registration apparatus being in an abnormal state, even in a range of the number of substitute channels other than the ordinary channels.

Note that any combination of the above constituent elements, and representations of the present embodiment converted between a method, an apparatus, a system, a recording medium, a computer program, or the like, are also effective as an aspect of the present embodiment.

### BRIEF DESCRIPTION OF THE DRAWINGS

FIG. 1 is a diagram illustrating a configuration of a network camera system according to a first exemplary embodiment.

FIG. 2 is a diagram illustrating a format of a recorder search command in the network camera system in FIG. 1.

FIG. 3 is a diagram illustrating a format of a recorder search command response in the network camera system in FIG. 1.

FIGS. 4A and 4B are diagrams illustrating a data structure of a system information table stored in a system information holding unit in FIG. 1.

FIG. 5 is a diagram illustrating a data structure of an own recorder information table stored in an own recorder information holding unit in FIG. 1.

FIG. 6 is a diagram illustrating a format of a camera search command in the network camera system in FIG. 1.

FIG. 7 is a diagram illustrating a format of the camera search command response in the network camera system in FIG. 1.

FIGS. 8A and 8B are diagrams illustrating another data structure of the system information table stored in the system information holding unit in FIG. 1.

FIG. 9 is a flowchart illustrating recorder ID determination processing by the recorder in FIG. 1.

FIG. 10 is a flowchart illustrating camera registration preliminary processing by the recorder in FIG. 1.

FIG. 11 is a flowchart illustrating camera registration processing by the recorder in FIG. 1.

FIG. 12 is a flowchart illustrating processing of detecting an abnormal state of another recorder by the recorder in FIG. 1.

FIG. 13 is a flowchart illustrating camera substitutive registration processing by the recorder in FIG. 1.

FIG. 14 is a flowchart illustrating recovery processing by the recorder in FIG. 1.

FIG. 15 is a flowchart illustrating another recovery processing by the recorder in FIG. 1.

FIG. 16 is a flowchart illustrating image data moving processing by the recorder in FIG. 1.

FIG. 17 is a diagram illustrating a configuration of an analog camera system according to a second exemplary embodiment.

FIGS. 18A and 18B are diagrams illustrating a data structure of a system information table stored in a system information holding unit in FIG. 17.

FIG. 19 is a diagram illustrating a configuration in a case where a second recorder of the analog camera system in FIG. 17 is in an abnormal state.

FIG. 20 is a flowchart illustrating recorder ID determination processing and matrix switch setting processing by a recorder 20 in FIG. 17.

FIG. 21 is a diagram illustrating a configuration of a network camera system according to a third exemplary embodiment.

FIGS. 22A, 22B and 22C are diagrams each illustrating a data structure of a connection position information table created by a switching hub in FIG. 21.

FIGS. 23A and 23B are diagrams each illustrating a data structure of a system information table stored in a system information holding unit in FIG. 21.

FIGS. 24A, 24B and 24C are diagrams each illustrating a data structure of a portion of the system information table in a case where the camera having a camera ID 2 fails, according to the third exemplary embodiment.

FIG. 25 is a flowchart illustrating setting processing of a new camera by a recorder.

### DETAILED DESCRIPTION

The invention will now be described by reference to the preferred embodiments. This does not intend to limit the scope of the present invention, but to exemplify the invention.

### First Exemplary Embodiment

Before giving specific description of the present invention, an overview will be described.

A first exemplary embodiment relates to a network camera system mutually connecting a plurality of cameras and a plurality of recorders via a network. In the first exemplary embodiment, each of the cameras is registered to any of the recorders, and image data is transmitted to the registered recorder. The recorder records image data received from the camera. Accordingly, in a case where a recorder is referred to as a “registration apparatus”, the camera is referred to as a “registration target apparatus”. In the present exemplary embodiment, an object is that, even in a case where any of the recorders fails, another recorder autonomously records the image data from the camera (hereinafter referred to as “substitute target camera”) registered in the failed recorder.

Moreover, in a case where there is a demand for reproducing the image data from the substitute target camera, and in a case where which recorder records the image data from the substitute target camera is unknown, reproduction of the image data would be difficult. Therefore, there is a need to easily reproduce the image data without being conscious of the recorder that records the image data from the substitute target camera. Furthermore, in a case where the failed recorder is replaced and then recovered, it would be difficult to return an operation state to the state before the failure without restoring the substitute target camera to the original recorder. Therefore, after replacement of the recorder, there is a need to connect the substitute target camera to the original recorder and restore the configuration before the failure. In order to solve at least one of these problems, the recorder according to the present exemplary embodiment executes the following processing.

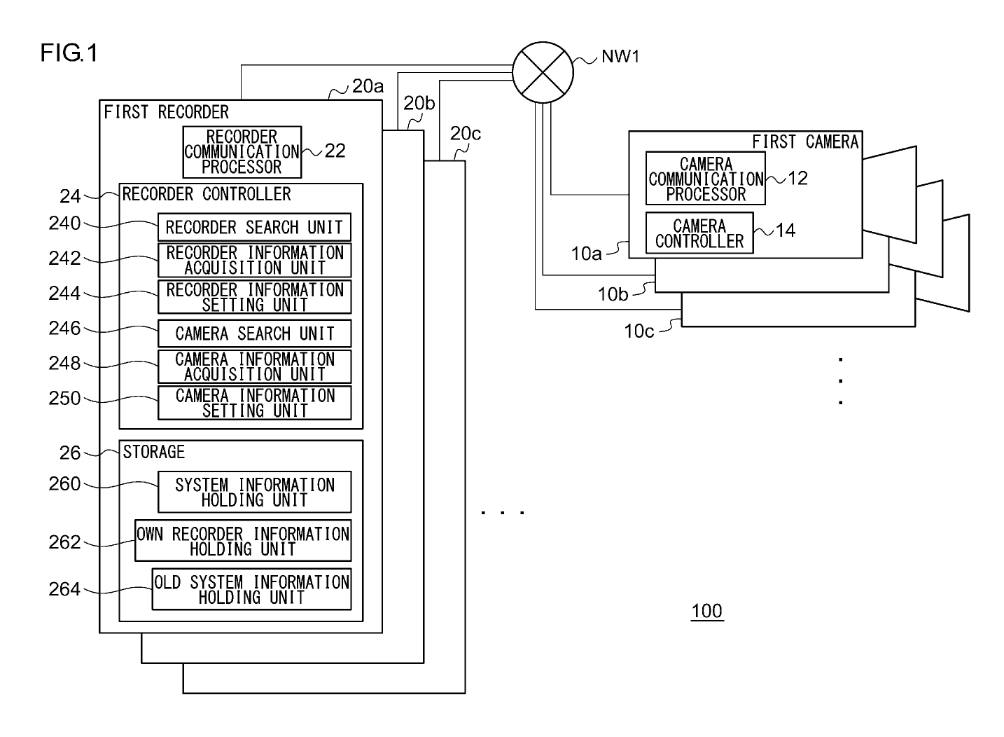

FIG. 1 illustrates a configuration of a network camera system 100 according to the present exemplary embodiment. The network camera system 100 includes a network NW1, a first camera 10a, a second camera 10b, and a third camera 10c, to be collectively referred to as a camera 10, and a first recorder 20a, a second recorder 20b, and a third recorder 20c, to be collectively referred to as a recorder 20. The number of cameras 10 is not limited to “three”, and the number of the recorders 20 is not limited to “three”. The camera 10 also includes a camera communication processor 12 and a camera controller 14. The recorder 20 includes a recorder communication processor 22, a recorder controller 24, and a storage 26. The recorder controller 24 includes a recorder search unit 240, a recorder information acquisition unit 242, a recorder information setting unit 244, a camera search unit 246, a camera information acquisition unit 248, and a camera information setting unit 250. The storage 26 includes a system information holding unit 260, an own recorder information holding unit 262, and an old system information holding unit 264.

The network NW1 may be a wired or wireless network, or a combination of both. The plurality of cameras 10 and the plurality of recorders 20 are connected to the network NW1. After the IP address is set for the camera 10, the camera 10 performs predetermined communication by data transmission-reception based on the IP address, and transmits imaging data of a captured moving image or still image (hereinafter referred to as “image data”) to a predetermined recorder 20 via the network NW1. Note that each of the cameras 10 is assumed to perform this predetermined communication with solely one recorder 20 due to processing performance, or the like. Accordingly, in a case where there is a request for this predetermined communication from the plurality of recorders 20, communication processing might fail in some cases.

The camera communication processor 12 performs data transmission-reception processing via the network NW1. An IP address is set to the camera communication processor 12. Before setting of the IP address, the IP address is a predetermined initial value. In a case where the IP address is a predetermined initial value, it is determined that the IP address has not been set. The initial value may be any value, for example, 192.168.0.2. The camera controller 14 controls the camera 10.

After being activated, each of the recorders 20 automatically performs initial setting processing, sets its own recorder ID (identification information) and own IP address, and together with this, sets an IP address of the camera 10 as necessary, and registers the camera 10. After the initial setting processing, each of the recorders 20 performs the above-described predetermined communication with the registered camera 10 using the set IP address, and records the image data transmitted from the registered camera 10 in the storage 26.

The recorder communication processor 22 performs data transmission-reception processing via the network NW1. An IP address is set to the recorder communication processor 22. Before setting of the IP address, the IP address is a predetermined initial value. This initial value may be any value, for example 192.168.0.3. The recorder communication processor 22 performs data transmission-reception based on the IP address on the basis of various command transmission instructions from the recorder controller 24. While the recorder communication processor 22 may perform data transmission-reception based on a media access control (MAC) address, this will be omitted in the following description. While the following describes that the recorder search unit 240 or the like included in the recorder controller 24 is directly performing command transmission, or the like, actual data transmission-reception is performed by the recorder communication processor 22.

For the sake of clarity of explanation, the configuration of the recorder 20 will be described below in the order of processing in the recorder 20. Specifically, description follows in the order of: 1. Initial setting processing; 2. Camera registration processing; 3. Ordinary state processing; 4. Abnormal state processing; and 5. Recovery processing.

1. Initial Setting Processing

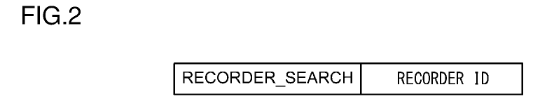

Each of the recorder search unit 240, the recorder information acquisition unit 242, and the recorder information setting unit 244 performs initial setting processing. The recorder search unit 240 broadcasts a recorder search command including a recorder ID onto the network NW1 and searches for another recorder 20 having the same recorder ID. FIG. 2 illustrates a format of the recorder search command in the network camera system 100. The recorder search command includes an identifier (RECORDER_SEARCH) of the recorder search command and the recorder ID to be a search target. Returning to FIG. 1.

In a case where the recorder ID of another recorder 20 is equal to the recorder ID of the recorder search command in the other recorder 20 that has received the recorder search command, the recorder search unit 240 in the other recorder 20 transmits a recorder search command response. In a case where the recorder ID of the other recorder 20 differs from the recorder ID of the recorder search command, the other recorder 20 does not transmit the recorder search command response. In the camera 10 that has received the recorder search command, no processing is performed.

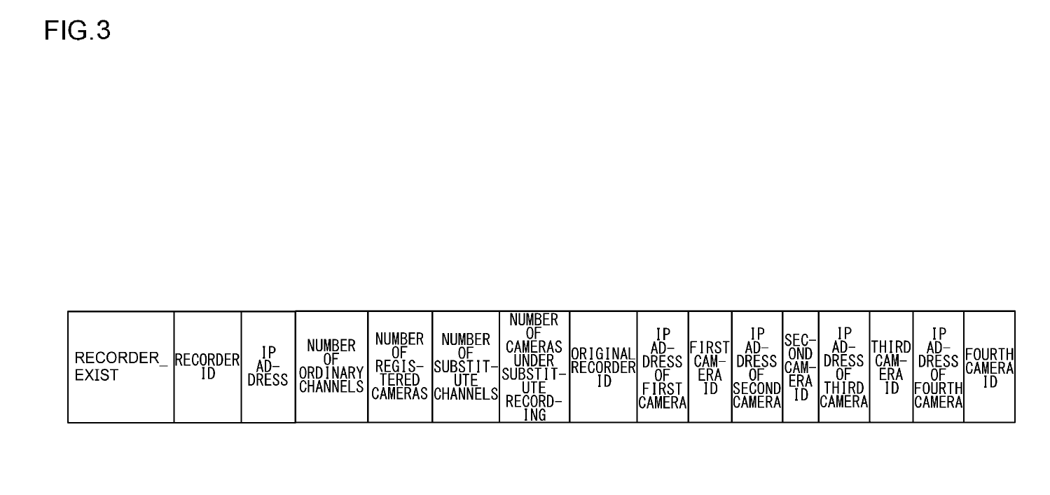

FIG. 3 illustrates a format of the recorder search command response in the network camera system 100. The recorder search command response includes an identifier (RECORDER_EXIST) of the recorder search command response, a recorder ID, an IP address, the number of ordinary channels, and the number of registered cameras. Moreover, the recorder search command response includes the number of substitute channels, the number of cameras under substitute recording, and the original recorder ID. Furthermore, the recorder search command response includes the IP address and the camera ID of the camera 10 registered by oneself.

The recorder ID indicates the recorder ID of another recorder 20 (hereinafter referred to as the recorder 20) that transmitted the recorder search command response. The IP address indicates the IP address set to the recorder 20. The number of ordinary channels indicates the maximum number of cameras 10 that can be registered to the recorder 20. The registered number of cameras indicates the number of cameras 10 registered to the recorder 20 and corresponds to a value within a range of the number of ordinary channels. As described above, since the recorder 20 registers the camera 10 to which the IP address has been set, the maximum number of cameras 10 that can be registered is the maximum number of cameras 10 to which the recorder 20 can set the IP addresses. Accordingly, the number of registered cameras 10 corresponds to the number of cameras 10 to which the recorder 20 has set IP addresses.

The number of substitute channels indicates the maximum number of cameras 10 in registration of the camera 10 already registered to another surrounding recorder 20 in a case where the other surrounding recorder 20 is in an abnormal state, as a substitute for the other surrounding recorder 20. Herein, the abnormal state indicates, for example, a state in which the other surrounding recorder 20 has difficulty in recording image data due to a failure, or a state in which the network is disconnected. Note that while the substitute channel is used for registering the camera 10 and receiving and recording image data from the camera 10 similarly to the ordinary channel, the substitute channel is available exclusively when the other surrounding recorder 20 is in an abnormal state. In contrast, the ordinary channel is constantly available during operation of the recorder 20. While a vacant channel among the ordinary channels may be used as a substitute channel, or need not be used as a substitute channel. The minimum value of the number of substitute channels may be determined and then, the number of remainder obtained by subtracting the number of substitute channels from the total number of channels of the recorder 20 may be used as the number of ordinary channels.

The number of cameras under substitute recording is the number of cameras 10 using the substitute channel in the recorder 20. The number of cameras under substitute recording is a value within the range of the number of substitute channels. In a case, however, where a vacant channel of the ordinary channels is used as the substitute channel, the number of cameras under substitute recording may be larger than the number of substitute channels. The original recorder ID is the ID of the recorder 20 to which the camera 10 using the substitute channel has been registered so far.

The IP address and the camera ID of the camera 10 registered by the recorder oneself are used not merely for the camera 10 using the ordinary channel but also for the camera 10 using the substitute channel. This recorder search command response can be considered to be the state information of the other recorder 20 connected to the network NW1. Registration of the camera 10 and the use of substitute channels will be described below. Returning to FIG. 1.

The recorder information acquisition unit 242 receives a recorder search command response from the other recorder 20 via the network NW1. Therefore, the recorder information acquisition unit 242 can also be an acquisition unit in the recorder 20. The recorder information acquisition unit 242 analyzes the received recorder search command response. The recorder information acquisition unit 242 acquires the state information of the recorder 20 that responded, namely, the recorder ID, the IP address, the number of ordinary channels, the number of registered cameras, the number of substitute channels, the number of cameras under substitute recording, the original recorder ID, and information of the camera 10.

Every time a response is received from the other recorders 20, the recorder search unit 240 increments the recorder ID from 1 by one, and sequentially searches for the other recorder 20. Accordingly, in a case where n (n is a positive integer) other recorders 20 exist, state information of n sets of recorders 20 is acquired. The system information holding unit 260 stores the state information of the recorders 20 acquired by the recorder information acquisition unit 242 as a system information table.

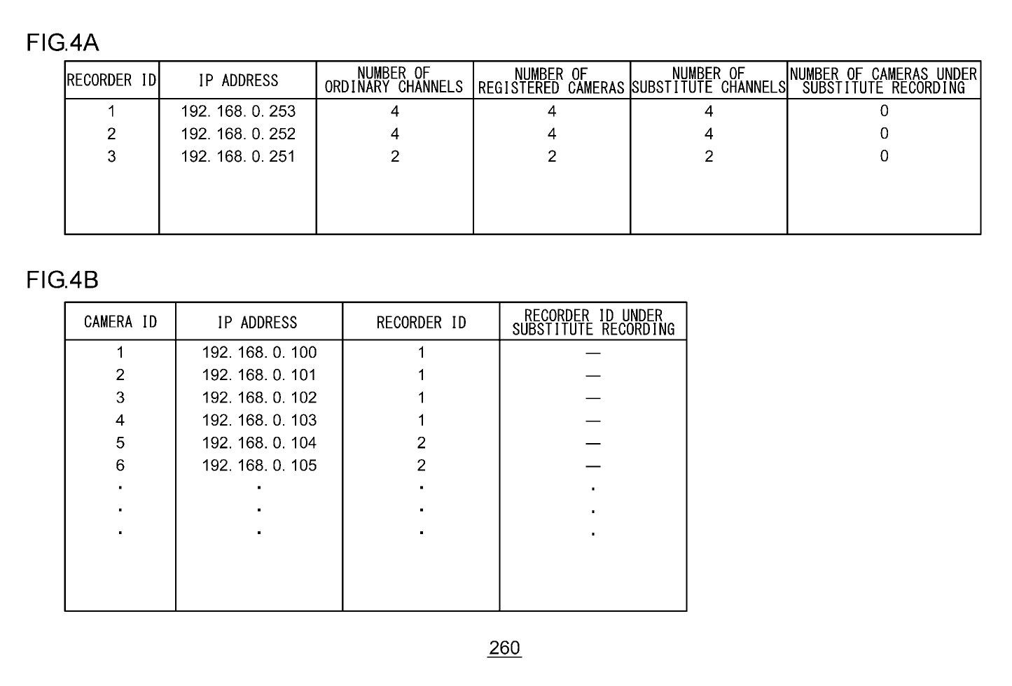

FIGS. 4A and 4B each illustrate a data structure of the system information table stored in the system information holding unit 260. FIG. 4A illustrates combinations of a plurality of recorder IDs, and IP addresses, the number of ordinary channels, the number of registered cameras, the number of substitute channels and the number of cameras under substitute recording, associated with each of the recorder IDs. FIG. 4B illustrates the camera ID and the IP address of the camera 10, the recorder ID of the recorder 20 that has registered the camera 10 using the ordinary channel, and the recorder ID under substitute recording for the camera 10. The recorder ID under substitute recording for the camera 10 corresponds to the recorder ID of the recorder 20 that has registered the camera 10 using the substitute channel. Returning to FIG. 1.

The recorder information setting unit 244 sets the recorder ID that is larger than the maximum ID by one among the recorder IDs acquired from the other recorders 20 as its own recorder ID with reference to the system information table. Moreover, the IP address of its own recorder 20 is to be set to avoid duplication with the IP address set in the other recorder 20. Note that the predetermined IP address value range (for example, 192.168.0.240 to 192.168.0.253) that can be set to the recorder 20 and a predetermined IP address range (for example, 192.168.0.100 to 192.168.0.200) that can be set to the camera 10 are defined beforehand and stored in the storage 26 of each of the recorders 20. It is allowable to configure to allow the predetermined IP address value range to be changed afterward.

The own recorder information holding unit 262 stores state information of its own recorder 20, namely, the recorder ID, the IP address, the number of ordinary channels, the number of registered cameras, the number of substitute channels, and the number of cameras under substitute recording, as its own recorder information table. These are the same as individual items in the recorder search command response.

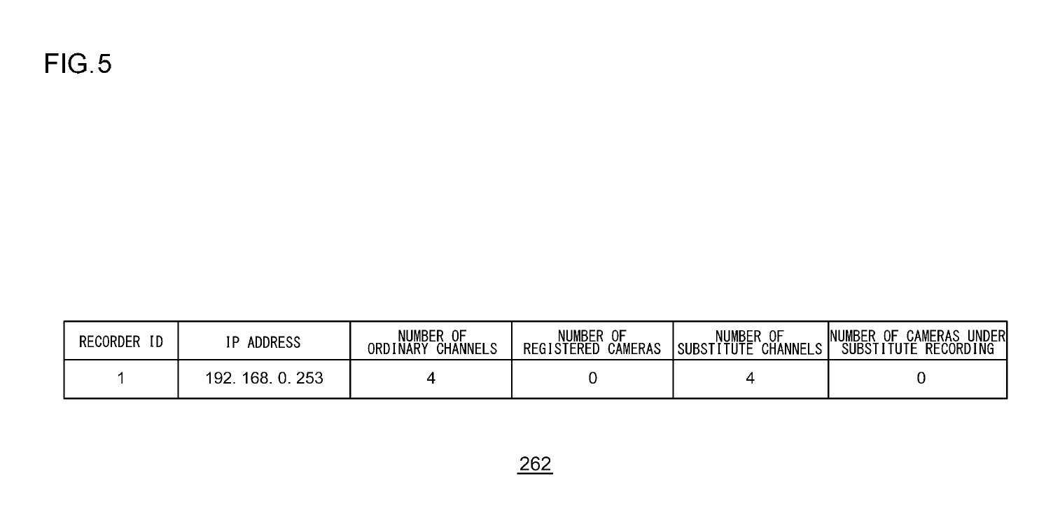

FIG. 5 illustrates a data structure of an own recorder information table stored in the own recorder information holding unit 262. The own recorder information table includes a recorder ID, an IP address, the number of ordinary channels, the number of registered cameras, the number of substitute channels, and the number of cameras under substitute recording. The recorder ID, the IP address, the number of registered cameras, and the number of cameras under substitute recording on the own recorder information table are changed and stored as appropriate when setting or the like of these values is performed. In contrast, the number of ordinary channels and the number of substitute channels are values determined by the specification of the recorder 20 and are not changed. Note that the number of registered cameras is zero until the camera registration processing is performed. Moreover, in a case where the other recorder 20 is not in the abnormal state, the number of substitute channels is zero. Returning to FIG. 1.

2. Camera Registration Processing

After the recorder ID is determined, in a case where the maximum number of cameras 10 has not been registered to the recorder 20 whose recorder ID is 1, the camera search unit 246, the camera information acquisition unit 248, and the camera information setting unit 250 execute camera registration processing described below. The case where the maximum number of cameras 10 has not been registered means that the number of registered cameras in the own recorder information table is smaller than the number of ordinary channels.

After the recorder ID is determined, in the recorder 20 whose recorder ID is other than 1, the recorder search unit 240 transmits a recorder search command and searches for the recorder 20 having a recorder ID smaller than its own recorder ID by one. The recorder information acquisition unit 242 acquires the number of ordinary channels, the number of registered cameras, the camera ID and the IP address of the camera 10 from the recorder search command response transmitted by the recorder 20 having the recorder ID smaller than the own recorder ID by one. In a case where this state information is acquired, the recorder 20 having the recorder ID smaller than its own recorder ID by one can be considered to be in the normal state. The normal state indicates a state in which the recorder 20 having a recorder ID smaller than its own recorder ID by one can record image data. In a case where the recorder 20 having the recorder ID smaller than its own recorder ID by one has registered the maximum number of cameras 10 and the own recorder 20 has not registered the maximum number of the cameras 10, the camera search unit 246, the camera information acquisition unit 248, and the camera information setting unit 250 execute the following camera registration processing.

Note that, in a case where the recorder 20 having the recorder ID smaller than its own recorder ID by one has already registered the maximum number of the cameras 10, all the recorders 20 having the recorders ID smaller than its own recorder ID have registered the maximum number of the cameras 10. This is because, as described above, the recorder ID is assigned to each of the recorders 20 in ascending order from 1 in the order of activation. It is also allowable to check whether all the recorders 20 having the recorders ID smaller than the own recorder ID have registered the maximum number of cameras 10.

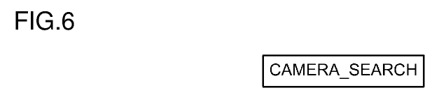

The camera search unit 246 broadcasts a camera search command onto the network NW1 and searches for a plurality of cameras 10. The camera search command may be transmitted by multicast transmission instead of broadcast transmission. FIG. 6 illustrates a format of the camera search command in the network camera system 100. The camera search command includes an identifier (CAMERA SEARCH) of the camera search command. Returning to FIG. 1.

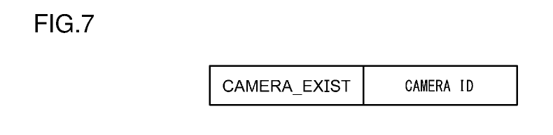

Each of the cameras 10 having received the camera search command transmits a camera search command response. FIG. 7 illustrates a format of the camera search command response in the network camera system 100. The camera search command response includes an identifier (CAMERA_EXIST) of the camera search command response and the camera ID of the camera 10. The camera ID is a unique value for each of the cameras, and for example, may be a MAC address. Note that the camera search command response may also include information indicating the type of the camera, such as a model name of the camera 10. Information indicating the type of the camera is referred to by the recorder 20 in order to achieve communication conforming to the specification of each of the cameras 10. Returning to FIG. 1.

The camera information acquisition unit 248 receives a camera search command response from the plurality of cameras 10 via the network NW1. The camera information acquisition unit 248 analyzes the camera search command response and acquires the camera ID.

On the basis of the camera ID acquired by the camera information acquisition unit 248, the camera information setting unit 250 specifies the camera 10 unregistered to another recorder 20 among the plurality of cameras 10, and sets an IP address of the specified camera 10 so as to avoid duplication. Specifically, the camera information setting unit 250 specifies the camera 10 having the camera ID not illustrated in FIG. 4B as the camera 10 unregistered to the other recorder 20, that is, the camera 10 having the IP address that has not been set yet.

Next, the camera information setting unit 250 instructs via the network NW1 to the camera 10 specified as a camera to which the IP address setting has not been completed, an IP address different from the set IP address indicated in the system information table stored in the system information holding unit 260, which is one IP address arbitrarily selected from the predetermined IP address range that can be set to the camera 10 described above, as the IP address of the camera 10. That is, the IP address is set so as to avoid duplication of the IP address within the network NW1. Note that this instruction is performed selectively for the camera 10 using the camera ID acquired by the camera search command response.

The camera information setting unit 250 registers the camera 10 to which the IP address has been set. Specifically, the camera information setting unit 250 registers information of the camera 10 to which the IP address has been set, onto the system information table. That is, in a case where another recorder 20 is in the normal state, the camera information setting unit 250 registers the unregistered camera 10 to the other normal recorder 20 within a range of the number of ordinary channels. This camera information setting unit 250 can be considered to be a registration unit.

3. Ordinary State Processing

After completion of the initial setting processing and the camera registration processing, the recorder 20 changes encoding setting, or the like, of the camera 10 registered to use the ordinary channel in accordance with the characteristics of the recorder 20 via the network NW1. Communication of changing the encoding setting, or the like, is also included in the above-described predetermined communication. Moreover, the recorder 20 requests the camera 10 registered to use the ordinary channel to transmit the image data to the own recorder 20 via the network NW1. In response to this request, the camera 10 transmits the image data to the recorder 20 via the network NW1. The recorder 20 records the received image data in the storage 26.

For example, in a case where ten cameras 10 are connected to the network NW1, each of the recorders 20 registers the camera 10 to the ordinary channel as follows unless the three recorders 20 have failed. The first recorder 20a registers the cameras 10 having the camera IDs 1 to 4 to the ordinary channel, the second recorder 20b registers the cameras 10 having the camera IDs 5 to 8 to the ordinary channel, and the third recorder 20c registers the cameras 10 having the camera IDs 9 and 10 to the ordinary channel. Each of the recorders 20 periodically transmits a recorder search command to the other recorder 20, and updates the system information table to the latest information on the basis of the received recorder search command response. Here, by receiving the system information table from the other recorder 20 to which the recorder search command has been transmitted, the recorder 20 confirms that the other recorder 20 is in a normal state.

4. Abnormal State Processing

In a case where the recorder search unit 240 transmits a recorder search command to the other recorder 20 and the recorder information acquisition unit 242 has not received the recorder search command response, the recorder information setting unit 244 determines that the other recorder 20 is in the abnormal state. As described above, the abnormal state indicates that it is faulty or that the network connection is disconnected. Herein, it is assumed that the recorder 20 having the recorder ID 2 has failed. The recorder information setting unit 244 of each of the recorders 20 without a failure recognizes, from the recorder search command response periodically acquired, that the recorder 20 having the recorder ID 2 has failed and that the cameras 10 having the camera IDs 5 to 8 have been registered to the recorder 20.

In a case where such recognition is made, the camera information setting unit 250 of at least one recorder 20 substitutively registers the camera 10 registered in the other recorder 20 that is in an abnormal state even in the range of the number of substitute channels other than the ordinary channel. That is, the camera 10 registered in the failed recorder 20 is assigned to the remaining recorder 20. Herein, the substitutive registration processing will be continuously described on the basis of the case where the recorder 20 having the recorder ID 2 is in the abnormal state.

The camera information setting unit 250 of the recorder 20 having the recorder ID 1 confirms that there is no recorder 20 having an ordinary channel in which additional registration is allowable, with reference to the system information table stored in the system information holding unit 260. Moreover, since the number of cameras under substitute recording in the system information table has not reached the number of substitute channels, the camera information setting unit 250 additionally registers the camera 10 registered in the recorder 20 having the recorder ID 2 until the number of cameras under substitute recording reaches the number of substitute channels.

The camera information setting unit 250 of the recorder 20 having the recorder ID 3 confirms that the recorder ID of (its own recorder ID-1) is the recorder 20 having the recorder ID 2 in failure. Furthermore, the camera information setting unit 250 confirms the channel currently under substitute recording by the recorder 20 on the basis of the recorder search command response from the recorder 20 having the (its own recorder ID-2), that is, the recorder ID 1. In a case where the cameras 10 have been registered up to the number of substitute channels in the recorder ID 1, the camera information setting unit 250 additionally registers the camera 10 registered in the recorder 20 having the recorder ID 2 until the number of cameras under substitute recording reaches the number of substitute channels. In a case where such a camera 10 has been registered to the recorder 20 having the recorder ID 1, the camera information setting unit 250 does not perform additional registration. In contrast, in a case where the cameras 10 have not been registered up to the number of substitute channels in the recorder ID 1, the camera information setting unit 250 does not perform additional registration and continues to confirm the number of cameras under substitute recording.

The recorder 20 having the recorder ID 4 and subsequent ID executes the processing similar to the processing of the case of the recorder 20 having the recorder ID 3. Here, since the number of cameras under substitute recording has not reached the number of substitute channels in the recorder 20 having the recorder ID of (own recorder ID-1), confirmation of the number of cameras under substitute recording is continued. As a result of this processing, the cameras 10 having the camera IDs 5 to 8 are registered in the substitute channels of the recorder 20 having the recorder ID 1. The recorder 20 having the recorder ID 1 notifies the camera 10 having the camera IDs 5 to 8 that the recorder 20 has been changed. In response to this, the camera 10 changes the transmission destination of the image data, and transmits the image data to the recorder 20 as a new transmission destination. The storage 26 of the recorder 20 having the recorder ID 1 substitutively records the image data from this camera 10. Hereinafter, this is also referred to as substitute recording. In a case where the recorder 20 having the recorder ID 2 is in the normal state and the recorder 20 having the recorder ID 1 is in the abnormal state, the recorder 20 having the recorder ID 2 performs the operation of the recorder 20 of the recorder ID 1 described above.

The recorder information setting unit 244 of the recorder 20 that has substitutively registered the camera 10 registered in the other recorder 20 being in the abnormal state updates the number of cameras under substitute recording in the own recorder information table of the own recorder information holding unit 262. This updating is also performed onto the system information table of the system information holding unit 260. Moreover, the recorder information setting unit 244 inputs its own recorder ID as the recorder ID under substitute recording in the system information table of the system information holding unit 260.

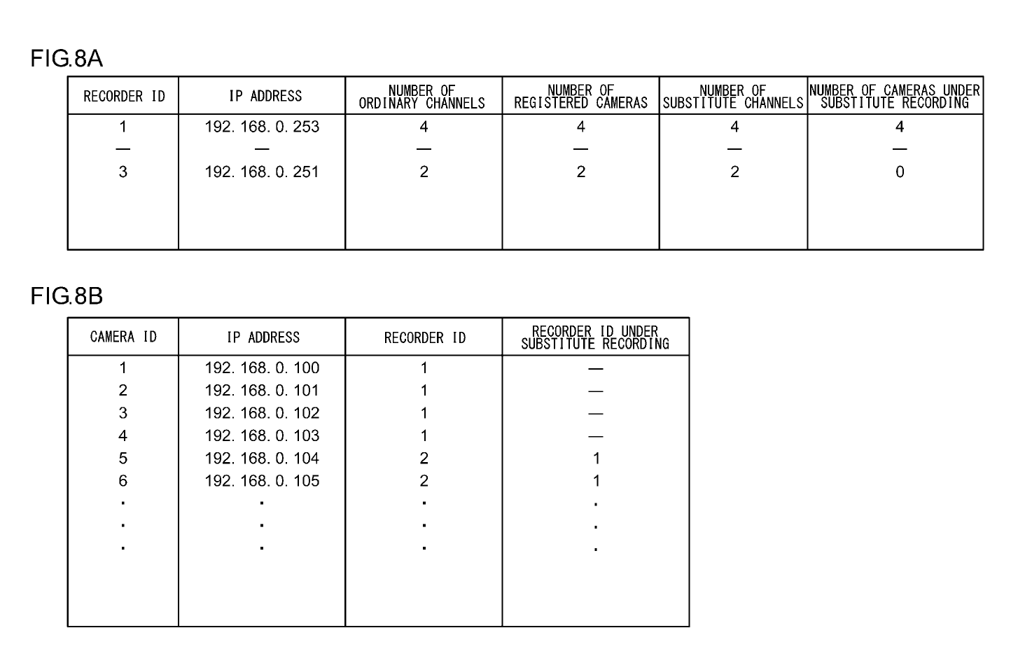

FIGS. 8A and 8B illustrate another data structure of the system information table stored in the system information holding unit 260. In FIG. 8A, the number of cameras under substitute recording for the recorder ID 1 is set to 4, and information on the recorder ID 2 is deleted. Moreover, in FIG. 8B, 1 is input as the recorder ID under substitute recording for the camera IDs 5 and 6. Returning to FIG. 1. Furthermore, the recorder information setting unit 244 stores the system information table before detecting the abnormal state (hereinafter referred to as an “old system information table”) in the old system information holding unit 264. That is, the old system information table before shifting to the abnormal state and the system information table under substitute recording are held at the same time. Both the processing are performed in order to restart the recording of the camera 10 that has been performed before shifting to the abnormal state at replacement of the other recorder 20 being in the abnormal state with the other new recorder 20.

Upon receiving the recorder search command from the other recorder 20, the recorder search unit 240 constructs a recorder search command response on the basis of the system information table under substitute recording stored in the system information holding unit 260. Therefore, the recorder search unit 240 inputs the value of the number of cameras under substitute recording indicated in FIG. 8A as the number of cameras under substitute recording in the recorder search command response. Moreover, the recorder search unit 240 inputs the value with the recorder ID in FIG. 8B as the original recorder ID in the recorder search command response. Furthermore, the recorder search unit 240 adds the camera ID and the camera IP address of the camera 10 under substitute recording, to the recorder search command response. The recorder search unit 240 transmits the recorder search command response constructed in this manner to the other recorder 20.

That is, regardless of whether the camera 10 has been substitutively registered, the recorder search unit 240 provides notification of the recorder search command response including the camera ID of the camera 10 registered in the camera information setting unit 250. Therefore, this camera ID includes the camera ID of the originally registered camera 10 and the camera ID of the substitutively registered camera 10. Furthermore, in a case where the camera 10 registered to the other recorder 20 being in the abnormal state is substitutively registered, the recorder search unit 240 also provides notification of the recorder ID of the other recorder 20 being in the abnormal state so as to be included in the recorder search command response. The other recorder 20 that has received this recorder search command response can grasp the situation of the substitutive registration of the camera 10.

A reproduction apparatus (not illustrated) such as a client PC is connected to the network NW1. The reproduction apparatus reproduces the image data recorded on the recorder 20 via the network NW1. The reproduction apparatus acquires a recorder search command response from each of the recorders 20 by transmitting a recorder search command before starting reproduction of image data. With this operation, the reproduction apparatus grasps the correspondence relationship between the camera 10 and the recorder 20. In a case where there is a demand for viewing the image data from the camera 10 registered to the recorder 20 being in the abnormal state, the reproduction apparatus instructs the other recorder 20 that substitutively registered the camera 10 to reproduce the image data. Subsequently, the reproduction apparatus receives and reproduces the image data received from the other recorder 20.

5. Recovery Processing

In the following, the processing in a case where the recorder 20 being in an abnormal state has been repaired and recovered, or where the recorder 20 has been replaced with a new recorder 20 will be described. Herein, these recorders 20 are referred to as “new recorders 20”, and the recorder 20 that substitutively registered the cameras 10 is referred to as a “substitute recorder 20”. The recorder search unit 240 of the new recorder 20 transmits a recorder search command while sequentially incrementing the recorder ID from the recorder 20 having the recorder ID 1. In a case where the recorder information acquisition unit 242 has received the recorder search command response, the system information holding unit 260 stores the state information of the recorder 20 acquired by the recorder information acquisition unit 242 as a system information table. The recorder information setting unit 244 specifies a recorder ID that is not in use on the basis of the system information table. Alternatively, the recorder information setting unit 244 may specify the recorder ID from the recorder ID that originally recorded the camera 10 including the recorder ID under substitute recording, on the basis of FIG. 8B. The recorder information setting unit 244 sets the specified recorder ID as its own recorder ID and also sets the IP address.

Moreover, the camera search unit 246, the camera information acquisition unit 248, and the camera information setting unit 250 register all the cameras 10 registered before the abnormal state, on the basis of the old system information table received from the other recorder 20. Note the system information table may be used instead of the old system information table. This corresponds to a pattern that in a case where the received recorder search command response includes the recorder ID of the new recorder 20 as the original recorder ID, the camera information setting unit 250 registers the camera 10 associated with the recorder ID within the range of the number of ordinary channels. After completion of registration of the camera 10, the recorder information setting unit 244 of the new recorder 20 updates the system information table stored in the system information holding unit 260. In a case where the recorder information acquisition unit 242 of the substitute recorder 20 receives the recorder search command response including the new recorder ID, the camera information setting unit 250 of the substitute recorder 20 finishes the substitutive registration of the camera 10, and finishes the recording.

The recorder search unit 240 of the new recorder 20 transmits an inquiry command for inquiring whether the substitutively recorded image data is held while sequentially incrementing the recorder ID from the recorder 20 having the recorder ID 1. The recorder communication processor 22 of the substitute recorder 20 that received the inquiry command transmits the image data stored in the storage 26. Note that the storage 26 of the substitute recorder 20 holds the information of the substitute channel used for substitute recording and the recording period and may search for the image data substitutively recorded on the basis of the information. The recorder communication processor 22 of the new recorder 20 receives the image data from the substitute recorder 20, and the storage 26 of the new recorder 20 stores the image data. Thereafter, the recorder communication processor 22 of the new recorder 20 transmits a deletion command of deleting the substitutively recorded image data to the substitute recorder 20.

While this configuration can be realized by a CPU, memory, or other LSI of an arbitrary computer in terms of hardware, and realized by a program loaded in a memory, etc., in terms of software, herein, the functional block to be realized by cooperation of both is illustrated. This makes it possible to realize these functional blocks in various forms solely by hardware, or a combination of hardware and software, which is to be understandable by those skilled in the art.

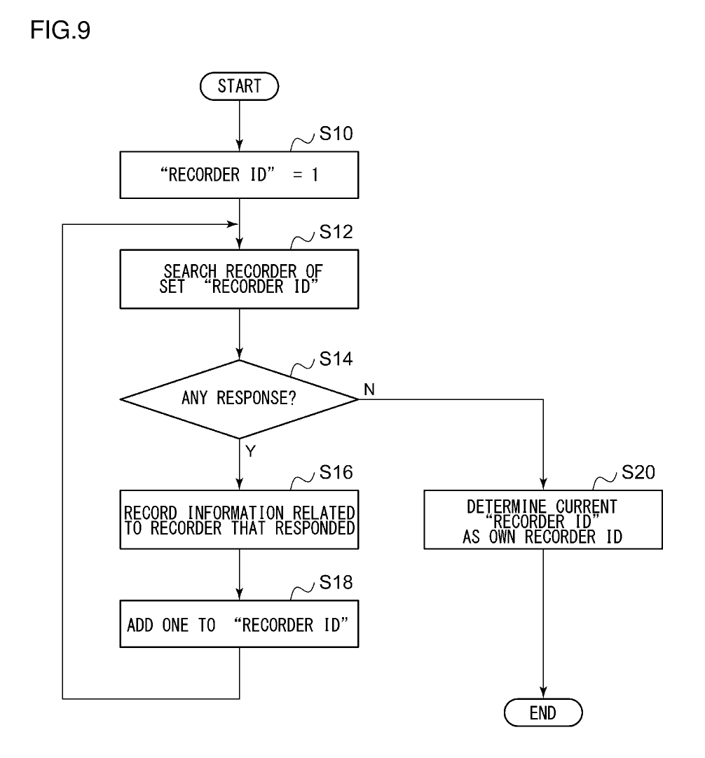

The operation of the network camera system 100 with the above configuration will be described. FIG. 9 is a flowchart illustrating the recorder ID determination processing by the recorder 20. After activation of the recorder 20, the recorder search unit 240 sets the recorder ID of the recorder search command to 1 (S10), and searches for the recorder 20 having the set recorder ID (S12). In a case where there is a response as the recorder search command response (Y in S14), the recorder information acquisition unit 242 acquires information related to the recorder 20 that responded, and the system information holding unit 260 stores the information as a system information table (S16). At that time, the recorder information acquisition unit 242 acquires the IP address and the camera ID of the registered camera 10 from the other recorder 20 by analyzing the recorder search command response.

The recorder search unit 240 adds one to the recorder ID (S18), and returns to the processing of step 12. In another case where there is no response as the recorder search command response (N in S14), the recorder information setting unit 244 determines the current recorder ID as its own recorder ID (S20) and finishes the processing. The determined recorder ID is stored as the recorder ID of the own recorder information table.

By executing this recorder ID determination processing by all the activated recorders 20, a unique recorder ID is assigned in ascending order from 1 to each of the recorders 20 in the order of activation, and together with this, an IP address is also assigned to each of the recorders 20 as described above. The recorder 20 that has completed the above recorder ID determination processing performs camera registration preliminary processing. Accordingly, the camera registration preliminary processing is started in the order of the recorder ID, from the recorder 20 having the recorder ID of 1. In some cases, the recorder 20 of the next recorder ID may start the camera registration preliminary processing while a certain recorder 20 is performing the camera registration preliminary processing.

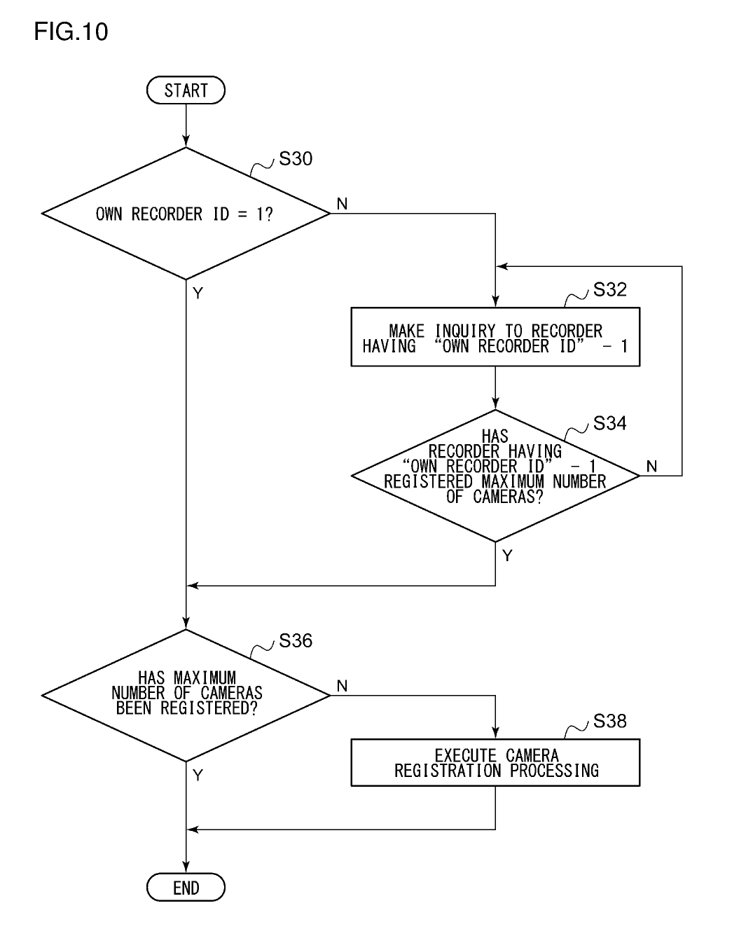

FIG. 10 is a flowchart illustrating camera registration preliminary processing by the recorder 20. In a case where its own recorder ID is 1 (Y in S30), the camera search unit 246 confirms whether the maximum number of cameras 10 has been registered (S36) with reference to the own recorder information table. In a case where the maximum number of cameras 10 has been registered (Y in S36), the processing ends. In a case where the maximum number of cameras 10 has not been registered (N in S36), the camera information setting unit 250 executes camera registration processing (S38).

In a case where the own recorder ID is not 1 (N in S30), the recorder search unit 240 makes an inquiry to the recorder 20 having a recorder ID smaller by one than its own recorder ID by using the recorder search command (S32). In a case where the recorder 20 has registered the maximum number of cameras 10 (Y in S34) with reference to the number of ordinary channels and the number of registered cameras of the recorder search command response as the response for this recorder search command, the processing proceeds to the above-described step 36. In a case where the recorder 20 has not registered the maximum number of cameras 10 (N in S34), the processing returns to step 32. When returning to step 32, it is allowable to provide a waiting time to avoid an occurrence of shortage of the band of the network NW1 by frequent inquiries to the recorder 20 in step 32.

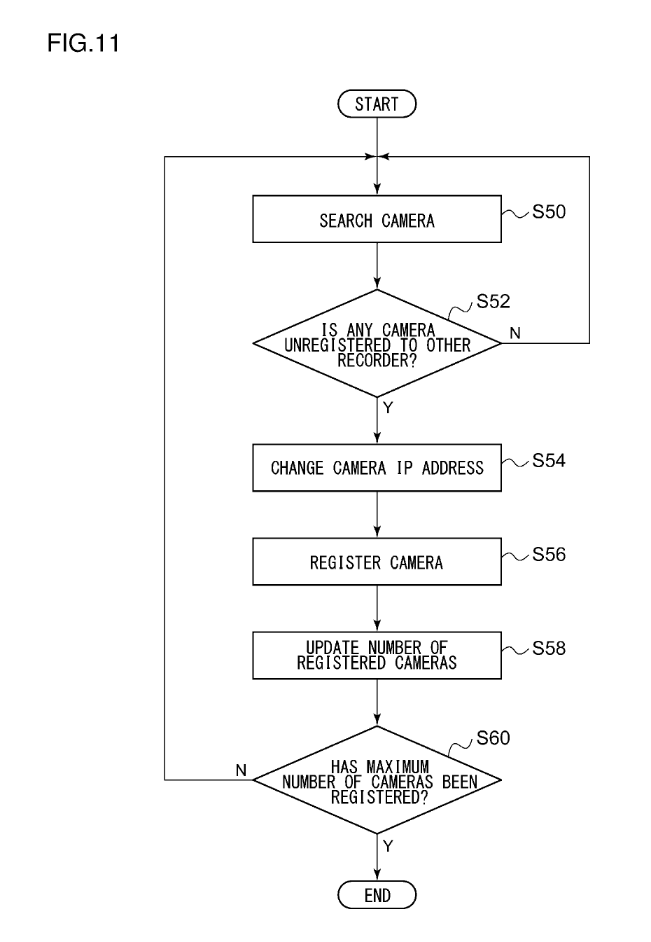

FIG. 11 is a flowchart illustrating camera registration processing by the recorder 20. The camera search unit 246 searches for the camera 10 (S50). In a case where there is no camera 10 unregistered to the other recorder 20 as a result of the search (N in S52), the processing returns to step 50. When returning to step 50, it is allowable to provide a waiting time to avoid an occurrence of shortage of the band of the network NW1 by frequent searches for the camera 10 in step 50.

In a case where there is a camera 10 that is unregistered to the other recorder 20 (Y in S52), the camera information setting unit 250 changes the IP address of one camera 10 among the specified cameras 10 (S54). Next, the system information holding unit 260 registers information related to this camera 10 (S56). Next, the camera information setting unit 250 updates the number of registered cameras (S58). Next, in a case where the maximum number of cameras 10 has been registered (Y in S60), the processing ends. In a case where the maximum number of cameras 10 has not been registered (N in S60), the processing returns to step 50. The recorder 20 having completed the camera registration processing receives the image data from the plurality of registered cameras 10 by using the IP addresses of the plurality of registered cameras 10.

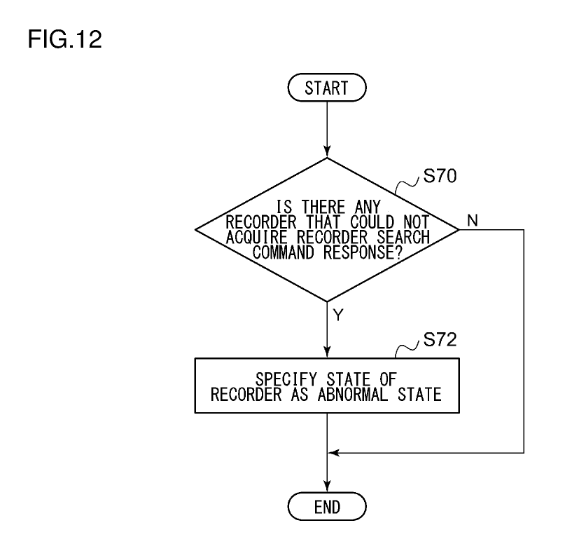

FIG. 12 is a flowchart illustrating processing of detecting an abnormal state of another recorder by the recorder 20. In a case where there is another recorder 20 from which the recorder information acquisition unit 242 could not receive the recorder search command response (Y in S70), the recorder information setting unit 244 specifies the state of the other recorder 20 as an abnormal state (S72). In a case where there is no other recorder 20 from which the recorder information acquisition unit 242 could not receive the recorder search command response (N in S70), the processing ends.

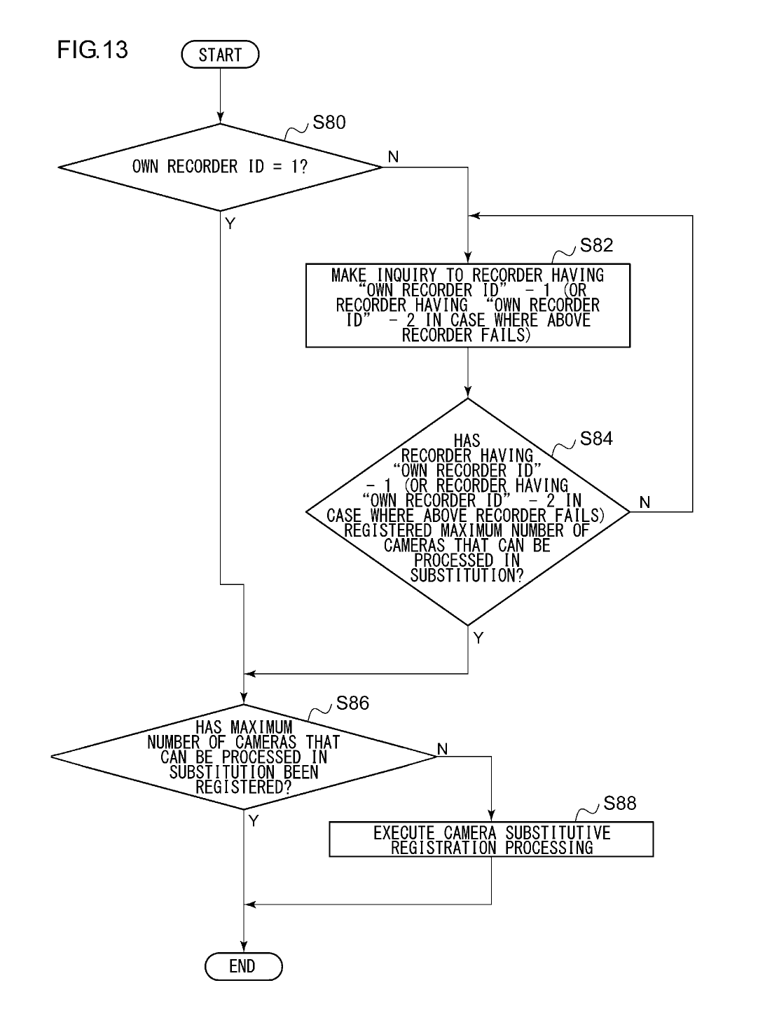

FIG. 13 is a flowchart illustrating camera substitutive registration processing by the recorder 20. Note that this processing is executed in parallel or sequentially in all the recorders 20. In a case where its own recorder ID is 1 (Y in S80), the camera search unit 246 confirms whether the maximum number of cameras 10 that can be processed in substitution has been registered (S86) with reference to the own recorder information table. In a case where the maximum number of cameras 10 that can be processed in substitution has been registered (Y in S86), the processing ends. In a case where the maximum number of cameras 10 that can be processed in substitution has not been registered (N in S86), the camera information setting unit 250 executes the camera substitutive registration processing (S88).

In a case where the own recorder ID is not 1 (N in S80), the recorder search unit 240 makes an inquiry to the recorder 20 having a recorder ID smaller by one than its own recorder ID by using the recorder search command (S82). In a case where the recorder 20 has registered the maximum number of cameras 10 that can be processed in substitution (Y in S84) with reference to the number of substitute channels, the number of cameras under substitute recording, and the camera ID in the recorder search command response as a response for this recorder search command, the processing proceeds to the above-described step 86. In a case where the recorder 20 has not registered the maximum number of camera 10 that can be processed in substitution (N in S84), the processing returns to step 82. When returning to step 82, it is allowable to provide a waiting time to avoid an occurrence of shortage of the band of the network NW1 by frequent inquiries to the recorder 20 in step 82.

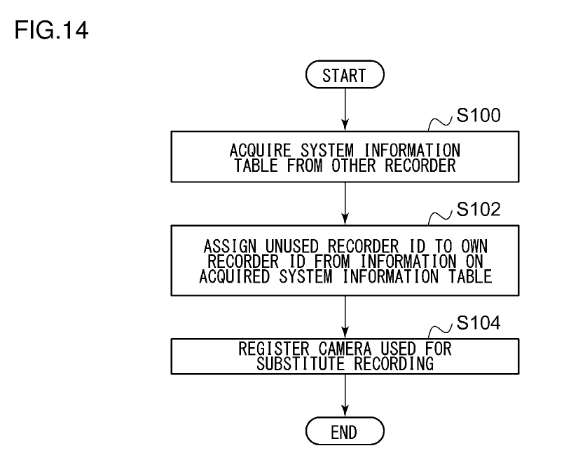

FIG. 14 is a flowchart illustrating recovery processing by the recorder 20. This corresponds to processing by the new recorder 20. The recorder information acquisition unit 242 receives a recorder search command response from another recorder 20, thereby acquiring a system information table (S100). The recorder information setting unit 244 assigns an unused recorder ID to its own recorder ID from information of the acquired system information table (S102). The camera information setting unit 250 registers the camera 10 used for substitute recording (S104).

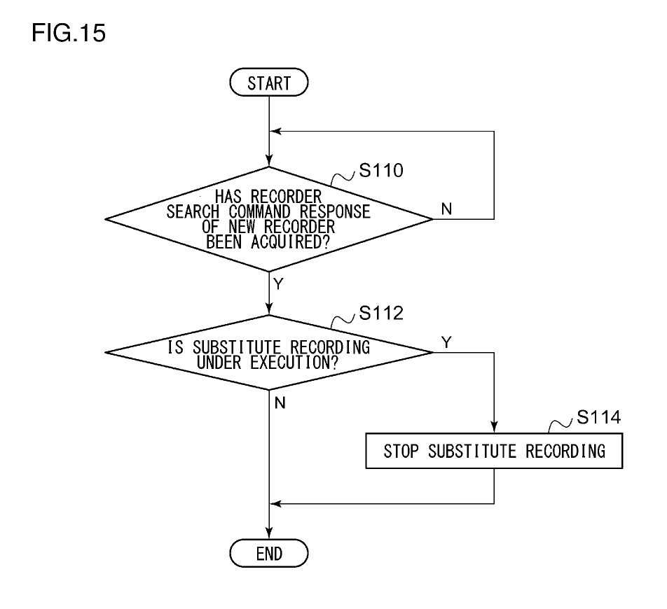

FIG. 15 is a flowchart illustrating another recovery processing by the recorder 20. This corresponds to the processing by the recorder 20 performing substitute recording. In a case where the recorder information acquisition unit 242 has not acquired the recorder search command response of the new recorder 20 (N in S110), the unit waits for the acquiring. In a case where the recorder information acquisition unit 242 has acquired the recorder search command response of the new recorder 20 (Y in S110), and in a case where the storage 26 is executing substitute recording (Y in S112), the substitute recording is stopped (S114). In a case where the storage 26 is not executing substitute recording (N in S112), the processing ends.

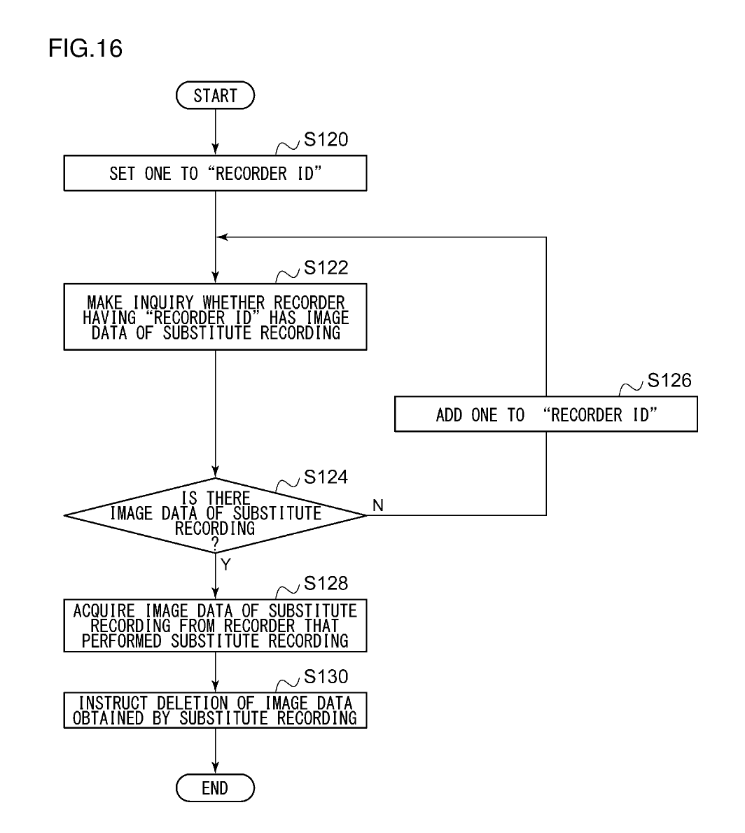

FIG. 16 is a flowchart illustrating image data moving processing by the recorder 20. This corresponds to processing by the new recorder 20. The recorder search unit 240 sets 1 to the recorder ID (S120). The recorder search unit 240 inquires whether the recorder 20 having the recorder ID has image data of substitute recording (S122). In a case where there is no image data of the substitute recording (N in S124), the recorder search unit 240 adds one to the recorder ID (S126) and returns to step 122. In a case where there is image data of the substitute recording (Y in S124), the storage 26 acquires the image data of the substitute recording from the recorder 20 that performed the substitute recording (S128). The recorder communication processor 22 instructs deletion of the image data obtained by substitution recording (S130).

According to the present exemplary embodiment, in a case where another recorder 20 is in an abnormal state, the camera 10 registered in the other recorder 20 is substitutively registered even in the range of the number of substitute channels other than the ordinary channel, making it possible to autonomously register the camera 10 even in case of an occurrence of abnormality. Moreover, since the camera 10 is autonomously registered even in a case of an occurrence of abnormality, the operation can be autonomously continued even in the case of the occurrence of abnormality. Moreover, in a case where the other recorder 20 is in a normal state, the ordinary channel for registering the unregistered camera 10 to the other recorder 20 being in the normal state and the substitute channel are set separately from each other, making it possible to substitutively register the camera 10 regardless of the registration status in the ordinary channel.

Moreover, in a case where the camera 10 registered in the other recorder 20 being in an abnormal state is substitutively registered, the recorder ID of the other recorder 20 is also included in the recorder search command response. This makes it possible to notify still another recorder 20 in the surroundings that the camera 10 has been substitutively registered. Moreover, since the still other recorder 20 in the surroundings is notified of the fact that the camera 10 has been substitutively registered, the still other recorder 20 in the surroundings can specify the next processing to be performed. Moreover, in a case where the camera 10 registered in the other recorder 20 being in an abnormal state is substitutively registered, the recorder ID of the other recorder 20 is also included in the recorder search command response. This makes it possible to easily return to the original state in a case where the other recorder 20 is recovered.

Moreover, in a case where the acquired recorder search command response includes the recorder ID of the present recorder 20, the camera 10 associated with the recorder ID is registered within the range of the number of ordinary channels, making it possible to register the original camera 10 in a case where the recorder 20 is recovered. Moreover, since the original camera 10 is registered in a case where the recorder 20 is recovered, it is possible to restore the state before the occurrence of the abnormal state. Moreover, even in a case where any one of the recorders 20 fails, the network camera system 100 as a whole is established, and thus, the system can return to the original system even when the recorder 20 recovers from a failure. Moreover, in a case where any one of the recorders 20 is in failure, image data recording by all the cameras 10 can be continued, and the user can view the image data by ordinary operation. Moreover, since substitute recording is executed autonomously without user intervention, it is possible to reduce the failure handling cost.

Moreover, by specifying the camera 10 unregistered to the other recorder 20, setting the IP address of the specified camera 10, and registering the camera 10 having the IP address set therefor, it is possible to avoid duplicate registration of a certain camera 10 to the plurality of recorders 20. Moreover, since the IP address of the camera 10 already set in the recorder 20 first connected is not to be changed by the recorder 20 later connected, it is possible to appropriately handle a situation in which the plurality of recorders 20 is connected to one network NW1. Moreover, since the camera 10 having an IP address of a predetermined initial value is specified as the camera 10 unregistered to the other recorder 20, it is possible to easily specify the camera 10 unregistered to the other recorder 20 simply by comparing the IP address of the camera 10 with the predetermined initial value.

Moreover, IP address setting for the camera 10 is performed in a case where the recorder 20 having the recorder ID smaller than the own recorder ID by one has registered the maximum number of cameras 10. With this configuration, the IP address setting for the camera 10 is performed in a case where all the recorders 20 having the recorder ID smaller than the own recorder ID have registered the maximum number of cameras 10. Accordingly, it is possible to avoid the IP address of the camera 10 from being changed during camera registration processing of the camera 10 performed by the other recorder 20. Therefore, it is possible to more reliably avoid duplicate registration. Furthermore, it is sufficient to confirm whether all of the plurality of recorders 20 connected to the same network have registered the maximum number of cameras 10 merely toward one recorder 20, making it possible to suppress an increase in the data amount on the network NW1 and reduce the time of the initial setting processing.

### Second Exemplary Embodiment

Next, a second exemplary embodiment will be described. The second exemplary embodiment relates to an analog camera system mutually connecting a plurality of cameras and a plurality of recorders via a coaxial cable and a matrix switch instead of a network. Each of the cameras is registered to any of the recorders, and transmits image data to the registered recorder via the coaxial cable and the matrix switch. The camera is also referred to as an analog camera, the recorder is also referred to as an analog recorder. Herein, the difference from the first exemplary embodiment will be mainly described.

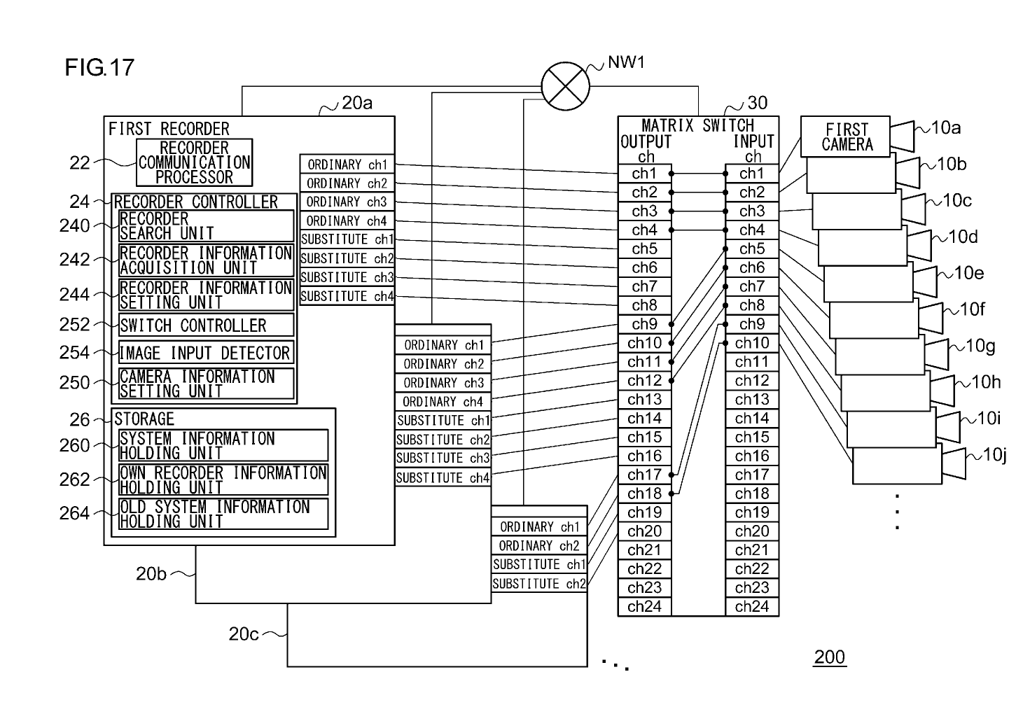

FIG. 17 illustrates a configuration of an analog camera system 200 according to the second exemplary embodiment. The analog camera system 200 includes a network NW1, a first camera 10a, a second camera 10b, a third camera 10c, a fourth camera 10d, a fifth camera 10e, a sixth camera 10f, a seventh camera 10g, an eighth camera 10h, a ninth camera 10i, and a tenth camera 10j, to be collectively referred to as a camera 10, a first recorder 20a, a second recorder 20b, and a third recorder 20c, to be collectively referred to as a recorder 20, and a matrix switch 30. The number of the cameras 10 is not limited to “10”, and the number of the recorders 20 is not limited to “three”. Moreover, the recorder controller 24 includes a recorder search unit 240, a recorder information acquisition unit 242, a recorder information setting unit 244, a camera information setting unit 250, a switch controller 252, and an image input detector 254. That is, the recorder controller 24 includes the switch controller 252 and the image input detector 254 in place of the camera search unit 246 and the camera information acquisition unit 248 of the first exemplary embodiment. The matrix switch 30 includes an input ch 1 to an input ch 24 and an output ch 1 to an output ch 24. The number of input chs and the number of output chs of the matrix switch 30 are not limited to “24”.

The network NW1 is not particularly limited and may be a network similar to that of the first exemplary embodiment or may be a network using serial communication by a serial interface, or the like. The plurality of recorders 20 and a matrix switch 30 are connected to the network NW1. Unlike the first exemplary embodiment, the camera 10 is not connected to the network NW1.

The camera 10 transmits image data to a predetermined recorder 20 via the matrix switch 30. No IP address is set to the camera 10. Each of the cameras 10 is sequentially connected to each of the input chs of the matrix switch 30 without omission of any input ch in order from input ch 1. That is, the first camera 10a is connected to the input ch 1, the second camera 10b is connected to the input ch 2, the third camera 10c is connected to the input ch 3, the fourth camera 10d is connected to the input ch 4, the fifth camera 10e is connected to the input ch 5, the sixth camera 10f is connected to the input ch 6, the seventh camera 10g is connected to the input ch 7, the eighth camera 10h is connected to the input ch 8, and the ninth camera 10i is connected to the input ch 9, and the tenth camera 10j is connected to the input ch 10, on the matrix switch 30. The cameras 10 and the input chs of the matrix switch 30 are connected with each other by wires such as coaxial cables.

An IP address is set beforehand to the matrix switch 30. This IP address may be any value, for example, 192.168.0.100. The matrix switch 30 connects each of the input chs to any one of the output chs in accordance with the control based on the IP address by the recorder 20 via the network NW1.

In each of the first recorder 20a and the second recorder 20b, for example, the number of ordinary channels is four and the number of substitute channels is four. In the third recorder 20c, for example, the number of ordinary channels is two and the number of substitute channels is two. The ordinary channel is also referred to as the ordinary ch, and the substitute channel is also referred to as the substitute ch.

Each of the recorders 20 is sequentially connected to each of the output chs of the matrix switch 30 without omission of any output ch in order from output ch 1. Specifically, in the first recorder 20a, the four ordinary chs 1 to 4 are connected to the output chs 1 to 4 of the matrix switch 30, respectively, and the four substitute chs 1 to 4 are connected to the output chs 5 to 8, respectively. In the second recorder 20b, the ordinary chs 1 to 4 are connected to the output chs 9 to 12 of the matrix switch 30, respectively, and the substitute chs 1 to 4 are connected to the output chs 13 to 16, respectively. In the third recorder 20c, the two ordinary chs 1 and 2 are connected to the output chs 17 and 18 of the matrix switch 30 respectively, and the two substitute chs 1 and 2 are connected to the output chs 19 and 20 respectively. The recorder 20 and the output chs of the matrix switch 30 are connected with each other by wires such as coaxial cables.

The recorder 20 is activated by the user in order from the one having the smaller output ch number of the matrix switch 30 connected to the recorder 20. That is, in the example in FIG. 17, the first recorder 20a, the second recorder 20b, and the third recorder 20c are activated in this order. Each of the recorders 20 having been activated automatically performs initial setting processing, sets its own recorder ID and IP address, connects the input ch and output ch of the matrix switch 30 related to its own recorder 20, and registers the camera 10. After the initial setting processing, each of the recorders 20 records the image data transmitted from the registered camera 10 in the storage 26.

For the sake of clarity of explanation, the configuration of the recorder 20 will be described below in the order of processing in the recorder 20. Specifically, description follows in the order of: 1. Initial setting processing; 2. Camera registration processing; 3. Ordinary state processing; 4. Abnormal state processing; and 5. Recovery processing.

1. Initial Setting Processing

Each of the recorder search unit 240, the recorder information acquisition unit 242, and the recorder information setting unit 244 performs initial setting processing. Similarly to the first exemplary embodiment, the recorder search unit 240 broadcasts a recorder search command including a recorder ID onto the network NW1 and searches for another recorder 20 having the same recorder ID.

In a case where the recorder ID of another recorder 20 is equal to the recorder ID of the recorder search command in the other recorder 20 that has received the recorder search command, the recorder search unit 240 in the other recorder 20 transmits a recorder search command response. The difference from the first exemplary embodiment is in that the recorder search command response does not include the IP address of the camera 10.

The recorder information acquisition unit 242 receives a recorder search command response from the other recorder 20 via the network NW1. The recorder information acquisition unit 242 acquires the state information of the recorder 20 that responded, namely, the recorder ID, the IP address, the number of ordinary channels, the number of registered cameras, the number of substitute channels, the number of cameras under substitute recording, the original recorder ID, and the camera ID.

Every time a response is received from the other recorders 20, the recorder search unit 240 increments the recorder ID from 1 by one, and sequentially searches for the other recorder 20. The system information holding unit 260 stores the state information of the recorders 20 acquired by the recorder information acquisition unit 242 as a system information table.

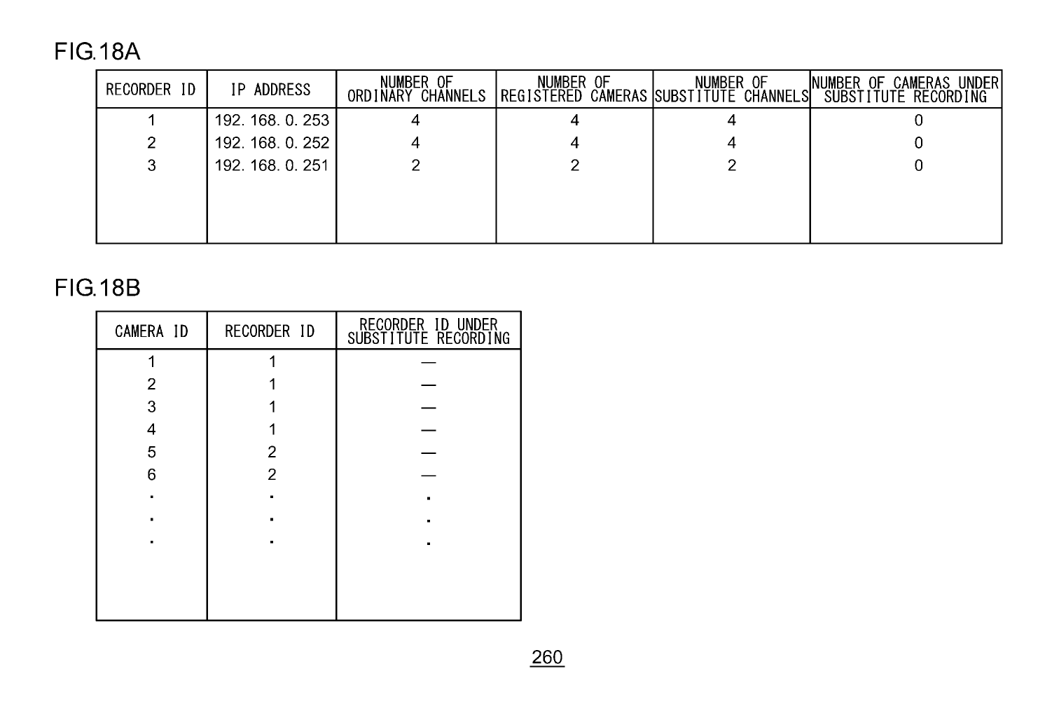

FIGS. 18A and 18B each illustrate a data structure of the system information table stored in the system information holding unit 260. FIG. 18A illustrates the same content as in FIG. 4A of the first exemplary embodiment. The difference from FIG. 4B is in that FIG. 18B does not include the IP address of the camera 10. The camera ID of the camera 10 illustrated in FIG. 18B is equal to the input ch number of the matrix switch 30 to which the camera 10 is connected. Returning to FIG. 17.

The switch controller 252 connects the input ch and the output ch of the matrix switch 30 on the basis of the state information acquired by the recorder information acquisition unit 242. Specifically, every time there is a response from the other recorder 20, the switch controller 252 sets a variable R to the number of ordinary channels of the recorder 20 that responded, and sets a variable S to the number of substitute channels of the recorder 20 that responded with reference to the system information table. Every time there is a response from the other recorder 20, the switch controller 252 adds the value of the variable R to a variable I, and adds the value of “variable R+variable S” to a variable O. Each of initial values of the variable I and the variable O is 1. In a case where there is no response from the other recorder 20, the switch controller 252 connects the input ch[I] and the output ch[O] of the matrix switch 30 using the current values of the variable I and the variable O.

The image input detector 254 detects whether there is an image input in the ordinary ch and the substitute ch of the own recorder 20. In a case where there is an image input in the ordinary ch 1 of the own recorder 20 in a state where the input ch[I] and the output ch[O] of the matrix switch 30 are connected with each other, the switch controller 252 connects, on the matrix switch 30, the input chs of the number of ordinary channels with the output chs of the number of ordinary channels from the input ch[I] and the output ch[O].

In a case where there is an image input in the ordinary ch 1 of its own recorder 20 in a state where the input ch[I] and the output ch[O] of the matrix switch 30 are connected with each other, the recorder information setting unit 244 sets its own recorder ID similarly to the first exemplary embodiment. Moreover, the IP address of its own recorder 20 is to be set so as to avoid duplication with the IP address set in the other recorder 20.

Similarly to the first exemplary embodiment, the own recorder information holding unit 262 stores the state information of the own recorder 20 as an own recorder information table.

The initially activated recorder 20 has no response from the other recorder 20 due to the absence of the other recorder 20 having the recorder ID 1. Accordingly, the switch controller 252 connects the input ch 1 and the output ch 1 of the matrix switch 30. In a case where there is an image input in the ordinary ch 1 of its own recorder 20, the recorder information setting unit 244 sets the recorder ID 1 as its own recorder ID. The switch controller 252 connects the input ch of the number of ordinary channels and the output ch of the number of ordinary channels from the input ch 1 and the output ch 1 in the matrix switch 30.

The recorder 20 other than the initially activated recorder 20 sequentially searches for the other recorder 20 in the order from the recorder ID 1, and holds the variable I obtained by adding the sum total of the number of ordinary channels of the recorder 20 that responded, and holds the variable O obtained by adding the sum total of the number of ordinary channels and the sum total of the number of substitute channels, on the recorder 20 that responded. In a case where there is no response from the other recorder 20 in a certain recorder ID, the switch controller 252 connects the input ch[I] and the output ch[O] of the matrix switch 30. In a case where there is an image input in the ordinary ch 1 of its own recorder 20, the recorder information setting unit 244 sets the recorder ID with no response as its own recorder ID. The switch controller 252 connects the input ch of the number of ordinary channels and the output ch of the number of ordinary channels from the input ch[I] and the output ch[O] in the matrix switch 30.

In a case where ten cameras 10 are connected to the network NW1 as in the example in FIG. 17, the input ch and the output ch of the matrix switch 30 are connected as follows in a case where the three recorders 20 have no failure. The output chs 1 to 4 are connected to input chs 1 to 4, respectively. The output chs 5 to 8 are not in connection. The output chs 9 to 12 are connected to the input chs 5 to 8, respectively. The output chs 13 to 16 are not in connection. The output chs 17 and 18 are connected to the input chs 9 and 10, respectively. This connection allows the camera 10 to be connected to the ordinary channels of each of the recorders 20 as follows. The cameras 10 having camera IDs 1 to 4 are connected to the ordinary chs 1 to 4 of the first recorder 20a, respectively. The cameras 10 having camera IDs 5 to 8 are connected to the ordinary chs 1 to 4 of the second recorder 20b, respectively. The cameras 10 having the camera IDs 9 and 10 are connected to the ordinary chs 1 and 2 of the third recorder 20c, respectively.

2. Camera Registration Processing

The recorder ID is determined and the input ch and the output ch of the matrix switch 30 are connected with each other, and thereafter, the camera information setting unit 250 executes camera registration processing in each of the recorders 20. That is, the camera information setting unit 250 registers the camera 10. Specifically, the camera information setting unit 250 registers the camera ID being the information related to the camera 10 onto the system information table. The camera information setting unit 250 sets the number of the input ch of the matrix switch 30 connected by the switch controller 252 as the camera ID. That is, similarly to the first exemplary embodiment, in a case where the other recorder 20 is in the normal state, the camera information setting unit 250 registers the unregistered camera 10 to the other recorder 20 being in the normal state within the range of the number of ordinary channels.

3. Ordinary State Processing

After completion of the initial setting processing and the camera registration processing, the camera 10 transmits the image data to the recorder 20 via the matrix switch 30. The recorder 20 records the received image data in the storage 26.

Each of the recorders 20 periodically transmits a recorder search command to the other recorder 20, and updates the system information table to the latest information on the basis of the received recorder search command response. Here, by receiving the system information table from the other recorder 20 to which the recorder search command has been transmitted, the recorder 20 confirms that the other recorder 20 is in a normal state.

4. Abnormal State Processing

Abnormal state processing is performed in a similar manner as in the first exemplary embodiment except that the connection between the input ch and the output ch of the matrix switch 30 is switched when substitutive registration processing is performed. Again, a case where the recorder 20 having the recorder ID 2 has failed is assumed. Similarly to the first exemplary embodiment, the recorder information setting unit 244 of each of the recorders 20 without a failure recognizes, from the recorder search command response periodically acquired, that the recorder 20 having the recorder ID 2 has failed and that the cameras 10 having the camera IDs 5 to 8 have been registered to the recorder 20. In a case where such recognition is made, the camera information setting unit 250 of at least one recorder 20 substitutively registers the camera 10 registered in the other recorder 20 being in an abnormal state even in the range of the number of substitute channels other than the ordinary channel. Moreover, in a case where the camera information setting unit 250 substitutively registers the camera 10 registered in the other recorder 20 being in the abnormal state, the switch controller 252 switches the connection between the input ch and the output ch of the matrix switch 30 such that the camera 10 registered in the other recorder 20 is to be connected to the substitute channel of the own recorder 20.

Similarly to the first exemplary embodiment, since the number of cameras under substitute recording in the system information table has not reached the number of substitute channels, the camera information setting unit 250 of the recorder 20 having the recorder ID 1 additionally registers the camera 10 registered in the recorder 20 having the recorder ID 2 until the number of cameras under substitute recording reaches the number of substitute channels

At this time, the switch controller 252 of the recorder 20 having the recorder ID 1 switches the connection between the input ch and the output ch of the matrix switch 30 such that the camera 10 registered in the recorder 20 having the recorder ID 2 is connected to the substitute channel of the own recorder 20 with reference to the system information table. From the system information table, the switch controller 252 recognizes that the camera IDs of the camera 10 registered in the recorder 20 having the recorder ID 2 are the camera IDs 5 to 8. Therefore, the switch controller 252 recognizes that it is sufficient to change the connection of the input chs 5 to 8 of the matrix switch 30 corresponding to the camera IDs 5 to 8, respectively. Moreover, from the system information table, the switch controller 252 recognizes that the substitute ch of the recorder 20 having the recorder ID 1 is connected from the output ch of the number obtained by adding one to the number of ordinary channels to the output ch of the number of substitute channels. That is, the switch controller 252 recognizes that the substitute ch of the recorder 20 having the recorder ID 1 is connected to the output chs 5 to 8 of the matrix switch 30. Accordingly, the switch controller 252 connects the input chs 5 to 8 and the output chs 5 to 8 of the matrix switch 30, respectively.

The recorder 20 having the recorder ID 3 and subsequent ID operates similarly to the first exemplary embodiment. In addition, in a case where the camera information setting unit 250 substitutively registers the camera 10 registered in the other recorder 20 being in an abnormal state, the switch controller 252 switches the connection between the input ch and the output ch of the matrix switch 30.

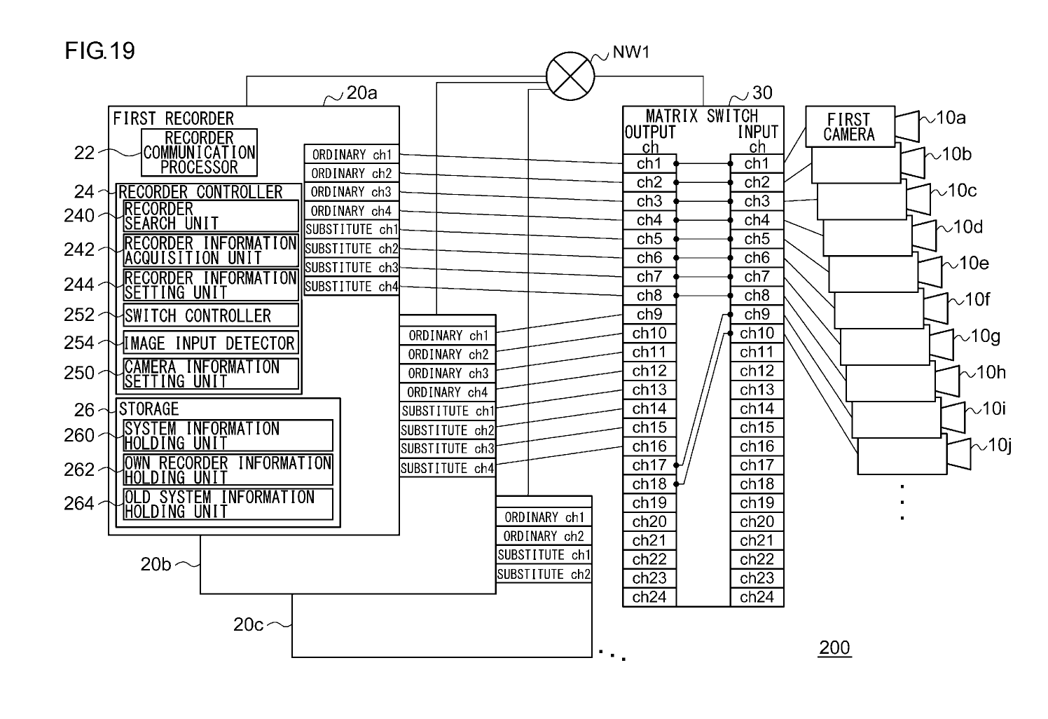

FIG. 19 illustrates a configuration in a case where the second recorder 20b of the analog camera system 200 is in an abnormal state. In FIG. 19, the connection of the matrix switch 30 differs from that in FIG. 17, and the output chs 5 to 8 are connected to the input chs 5 to 8, respectively. The cameras 10 having the camera IDs 5 to 8 are registered in the recorder 20 having the recorder ID 1, and connected to the substitute chs 1 to 4 of the recorder 20, respectively. With this configuration, the storage 26 of the recorder 20 having the recorder ID 1 substitutively records the image data from the cameras 10 having camera IDs 5 to 8.

A reproduction apparatus (not illustrated) such as a client PC is connected to the network NW1. Similarly to the first exemplary embodiment, the reproduction apparatus reproduces the image data recorded in the recorder 20 via the network NW1. The reproduction apparatus acquires a recorder search command response from each of the recorders 20 by transmitting a recorder search command before starting reproduction of image data. With this operation, the reproduction apparatus grasps the correspondence relationship between the camera 10 and the recorder 20, and reproduces the desired image data via the network NW1.

5. Recovery Processing

The recovery processing is performed similarly to the first exemplary embodiment except that the connection of the matrix switch 30 is switched when the camera 10 under substitute recording is registered. Similarly in the following, the processing in a case where the recorder 20 being in an abnormal state has been repaired and recovered, or where it has been replaced with a new recorder 20 will be described.

The camera information setting unit 250 of the new recorder 20 registers all the cameras 10 registered before the abnormal state on the basis of the old system information table received from the other recorder 20. At this time, the switch controller 252 of the new recorder 20 switches the connection between the input ch and the output ch of the matrix switch 30 such that the camera 10 registered before the abnormal state is connected to the ordinary channel of the new recorder 20 with reference to the old system information table. From the old system information table, the switch controller 252 recognizes that the camera IDs of the camera 10 registered before the abnormal state are the camera IDs 5 to 8. Therefore, the switch controller 252 recognizes that it is sufficient to change the connection of the input chs 5 to 8 of the matrix switch 30. Moreover, from the old system information table, the switch controller 252 recognizes that the ordinary channel of the new recorder 20 is connected from the output ch of the number obtained by adding one to the sum total of the number of ordinary channels and the number of substitute channels of the recorder 20 having the recorder ID smaller than the recorder ID of the new recorder 20, to the output ch of the number of ordinary channels of the new recorder 20. That is, the switch controller 252 recognizes that the ordinary channels of the new recorder 20 are connected to the output chs 9 to 12 of the matrix switch 30. Therefore, the switch controller 252 connects the input chs 5 to 8 and the output chs 9 to 12 of the matrix switch 30, respectively.

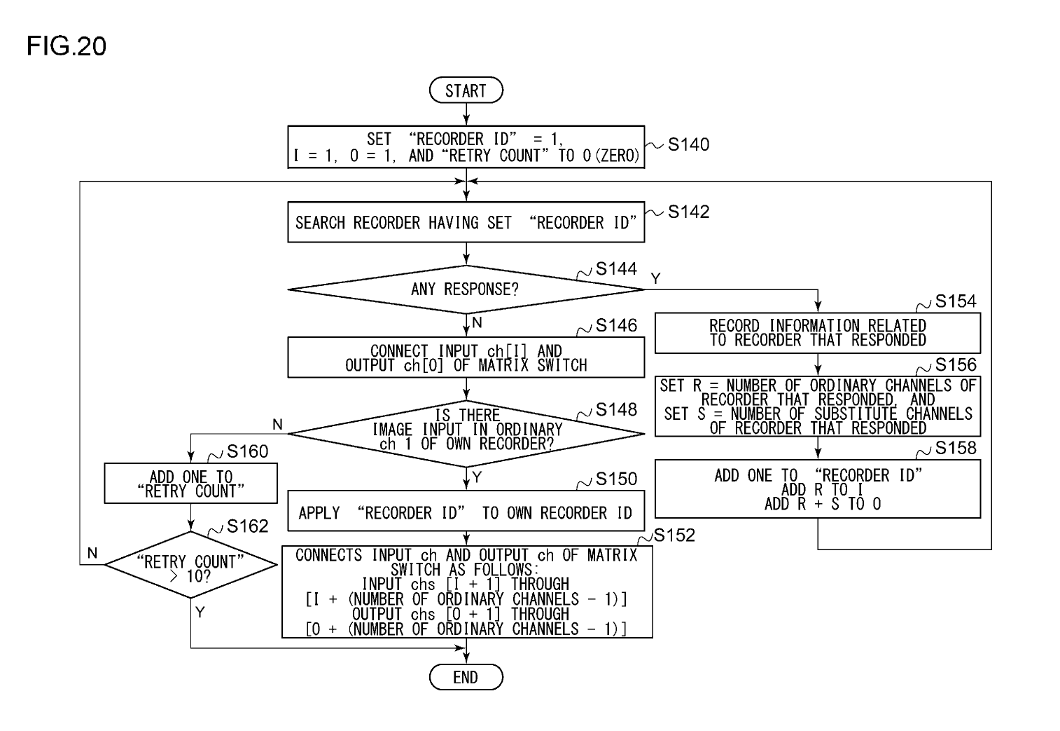

The operation of the above-configured analog camera system 200 will be described. FIG. 20 is a flowchart illustrating the recorder ID determination processing and the matrix switch setting processing by the recorder 20. After activation of the recorder 20, the recorder search unit 240 sets the recorder ID of the recorder search command to 1, sets the “retry count” to 0, and the switch controller 252 sets the variable I to 1, while setting the variable O to 1 (S140). The recorder search unit 240 searches for the recorder 20 having the set recorder ID (S142).

In a case where there is no response as the recorder search command response (N in S144), the switch controller 252 connects the input ch[I] and the output ch[O] of the matrix switch 30 (S146). In a case where the image input detector 254 detects that there is an image input in the ordinary ch 1 of its own recorder 20 (Y in S148), the recorder information setting unit 244 determines the current recorder ID as its own recorder ID (S150). Note that the determined recorder ID is stored as the recorder ID of the own recorder information table. The switch controller 252 connects the input chs [I+1] through [I+(number of ordinary channels−1)] of the matrix switch 30 to the output chs [O+1] through [O+(number of ordinary channels−1)] of the matrix switch 30 (S152). In step 152, the camera information setting unit 250 registers the camera ID of the camera 10 connected to its own recorder 20 onto the system information table, and finishes the processing.

In a case where the image input detector 254 has not detected the presence of an image input to the input ch 1 of its own recorder 20 (N in S148), the recorder search unit 240 adds one to the “retry count” (S160), and when the “retry count” is smaller than or equal to 10 (N in S162), the processing returns to the processing of step 142 and the recorder 20 of the current recorder ID is searched again. After that, in a case where the presence of an image input in the input ch 1 of its own recorder 20 has not been detected and the “retry count” exceeds 10 by repeated processing up to step 148 (Y in S162), the processing ends. While the exemplary number of times of repetition is 10 in the description, it is not limited thereto. In a case where the processing ends without detecting the presence of image input in this manner, there is a possibility that the connection between the camera 10 and the matrix switch 30, or the connection between the recorder 20 and the matrix switch 30 is incorrect.

In a case where there is a response as the recorder search command response (Y in S144), the recorder information acquisition unit 242 acquires the information related to the recorder 20 that responded, and the system information holding unit 260 stores the information as the system information table (S154). At that time, the recorder information acquisition unit 242 acquires the camera ID of the registered camera 10 from the other recorder 20 by analyzing the recorder search command response.

The switch controller 252 sets the variable R to the number of ordinary channels of the recorder 20 that responded, and sets the variable S to the number of substitute channels of the recorder 20 that responded, with reference to the system information table (S156). The recorder search unit 240 adds one to the recorder ID, the switch controller 252 adds the value of the variable R to the variable I, adds the value of “variable R+variable S” to the variable O (S158), and returns to the processing of step 142.

By executing the recorder ID determination processing and the matrix switch setting processing by all the activated recorders 20, a unique recorder ID is assigned in ascending order from 1 to each of the recorders 20 in the order of connection to the matrix switch 30, and together with this, an IP address is also assigned to each of the recorders 20 as described above. Moreover, the input ch and the output ch of the matrix switch 30 are connected with each other, and the ordinary channel of each of the recorders 20 is connected to the camera 10 via the matrix switch 30.

The processing of detecting an abnormal state of the other recorder by the recorder 20 is performed similarly to the flowchart in FIG. 12 according to the first exemplary embodiment.

While the camera substitutive registration processing by the recorder 20 is performed similarly to the flowchart in FIG. 13 of the first exemplary embodiment, additional processing is performed in step 88. That is, in step 88, the camera information setting unit 250 executes camera substitutive registration processing, and the switch controller 252 switches the connection between the input ch and the output ch of the matrix switch 30.

While the recovery processing by the recorder 20 is performed similarly to the flowchart in FIG. 14 of the first exemplary embodiment, additional processing is performed in step 104. That is, in step 104, the camera information setting unit 250 registers the camera 10 under substitution recording, and the switch controller 252 switches the connection between the input ch and the output ch of the matrix switch 30.

Another recovery processing by the recorder 20 is performed similarly to the flowchart in FIG. 15 of the first exemplary embodiment. Image data movement processing by the recorder 20 is performed similarly to the flowchart in FIG. 16 of the first exemplary embodiment.

According to the present exemplary embodiment, since each of the recorders 20 automatically performs initial setting processing, it is possible to reduce the initial setting cost in the analog camera system 200. Among the effects of the first exemplary embodiment, effects related to 4. Abnormal state processing and 5. Recovery processing can also be obtained.

### Third Exemplary Embodiment

Next, a third exemplary embodiment will be described. In a case where the camera fails and the user replaces the failed camera, applying various settings such as the same IP address as the failed camera to the new camera and thereafter connecting the new camera to the network might take a large amount of man-hours and might induce an error in the setting. Moreover, in a case where a plurality of cameras fails, it is necessary to connect each of the cameras with various settings having been applied to a correct connection position on the network. This would need to distinguishably manage each of the plurality of cameras with various settings having been applied, which would take much time and effort. In view of this, the third exemplary embodiment aims to achieve, even in a case of camera failure, application of various settings to the replaced camera merely by replacing the failed camera, and enabling recovery of the network camera system without performing setting on the camera by the user. Herein, the difference from the first exemplary embodiment will be mainly described.

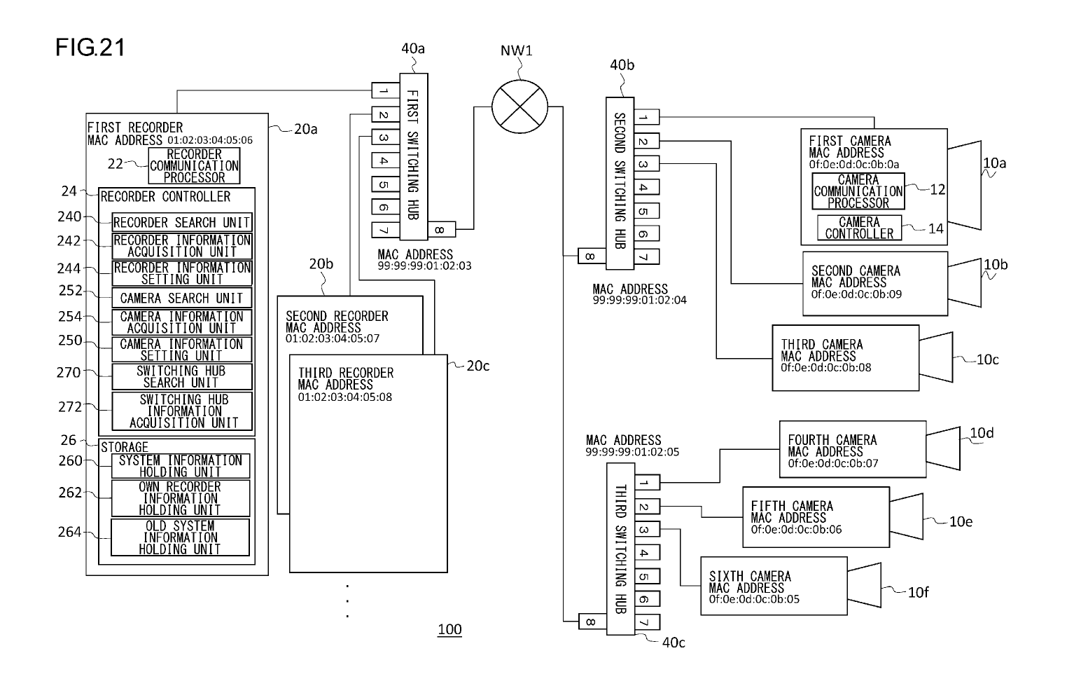

FIG. 21 illustrates a configuration of the network camera system 100 according to the third exemplary embodiment. In addition to the configuration of the first exemplary embodiment, the network camera system 100 further includes a fourth camera 10d, a fifth camera 10e, and a sixth camera 10f, to be collectively referred to as the camera 10, and a first switching hub 40a, a second switching hub 40b, and a third switching hub 40c, to be collectively referred to as a switching hub 40. Herein, the number of the cameras 10 is not limited to “six”, and the number of the switching hubs 40 is not limited to “three”.

A plurality of cameras 10 and a plurality of recorders 20 are connected to the network NW1 via a plurality of switching hubs 40. In the recorder 20, in addition to the configuration of the first exemplary embodiment, the recorder controller 24 further includes a switching hub search unit 270 and a switching hub information acquisition unit 272.

Each of the switching hubs 40 includes ports 1 to 8. The number of ports of the switching hub 40 is not limited to “eight”. In the first switching hub 40a, the port 1 is connected to the first recorder 20a, the port 2 is connected to the second recorder 20b, the port 3 is connected to the third recorder 20c, and the port 8 is connected to the network NW1. In each of the switching hubs 40, the ports 4 to 7 are not in connection.

In the second switching hub 40b, the port 1 is connected to the first camera 10a, the port 2 is connected to the second camera 10b, the port 3 is connected to the third camera 10c, and the port 8 is connected to the network NW1. In the third switching hub 40c, the port 1 is connected to the fourth camera 10d, the port 2 is connected to the fifth camera 10e, the port 3 is connected to the sixth camera 10f, and the port 8 is connected to the network NW1.

Each of the switching hubs 40 can acquire a MAC address of the device connected to each of the ports, and creates a connection position information table by associating the acquired MAC address with the port number. The switching hub ID is set to each of the switching hubs 40 beforehand, and the switching hub ID is also included in the connection position information table. The connection position (hereinafter referred to as “connection position”) of each of the cameras 10 and each of the recorders 20 on the network NW1 is represented by the switching hub ID and the port number. That is, the connection position information table includes connection position information indicating the connection position of each of the cameras 10 and each of the recorders 20, the MAC address (unique information) unique to each of the cameras 10, and the MAC address unique to each of the recorders 20.

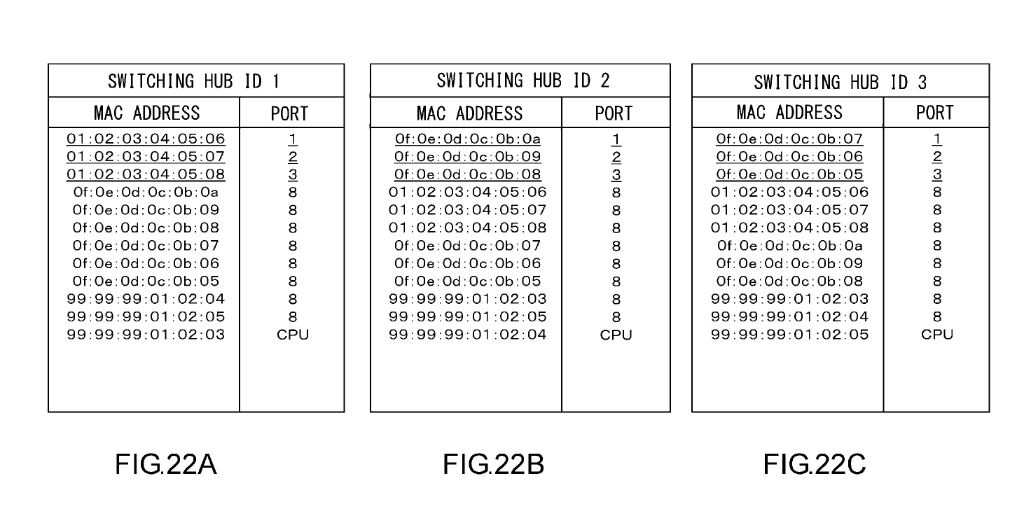

FIGS. 22A to 22C are diagrams each illustrating a data structure of a connection position information table created by the switching hub 40 in FIG. 21. FIG. 22A illustrates the plurality of ports of the first switching hub 40a having a switching hub ID 1 and the MAC address associated with each of the ports. FIG. 22B illustrates the plurality of ports of the second switching hub 40b having a switching hub ID 2 and the MAC address associated with each of the ports. FIG. 22C illustrates the plurality of ports of the third switching hub 40c having a switching hub ID 3 and the MAC address associated with each of the ports. In each of the switching hubs 40, since the port 8 is connected to a plurality of devices via the network NW1, a plurality of MAC addresses is associated with the port 8 in the connection position information table.

For the sake of clarity of explanation, the configuration of the recorder 20 will be described below in the order of processing in the recorder 20. Specifically, description follows in the order of: 1. Initial setting processing; 2. Camera registration processing; 3. Ordinary state processing; 4. Camera replacement processing 5. Recorder abnormal state processing; and 6. Recorder recovery processing. Note that after 3. Ordinary state processing and before 4. Camera replacement processing, there might be cases where 5. Recorder abnormal state processing and 6. Recorder recovery processing are performed.

1. Initial Setting Processing

In the initial setting processing, registration processing of the connection position of the recorder 20 is also performed in addition to the processing of the first exemplary embodiment. Here, the recorder search command response transmitted by the recorder search unit 240 includes the information in FIG. 3, and further includes the MAC address of its own recorder 20, the connection position of the recorder 20, the model name of the recorder 20, the operation setting information of the recorder 20, the MAC address of the camera 10 registered by the recorder 20, the connection position of the camera 10, the model name of the camera 10, and operation setting information of the camera 10. The operation setting information of the recorder 20 is information for setting the operation of the recorder 20. The operation setting information of the camera 10 is information for setting the operation of the camera 10 and includes encoding setting.

In a case where the recorder information setting unit 244 sets the recorder ID and the IP address of its own recorder 20 as in the first exemplary embodiment, the switching hub search unit 270 transmits a switching hub search command to the plurality of switching hubs 40. Upon receiving the switching hub search command, each of the switching hubs 40 transmits a connection position information table to the recorder 20. The switching hub information acquisition unit 272 acquires the connection position information table from each of the switching hubs 40.

The recorder information setting unit 244 specifies the connection position of the own recorder 20, on the basis of the acquired connection position information table and the MAC address of the own recorder 20. Specifically, the recorder information setting unit 244 specifies, as the connection position, a port associated with solely its own MAC address and a switching hub ID of the connection position information table including the port.

The own recorder information holding unit 262 stores the information of the first exemplary embodiment, and further stores the connection position of its own recorder 20 that has been specified, the MAC address of the recorder 20, and the model name of the recorder 20, as the own recorder information table. Moreover, the system information holding unit 260 stores these pieces of information as the system information table. Moreover, the system information holding unit 260 and the own recorder information holding unit 262 also register the operation setting information of its own recorder 20 in association with the recorder ID of the recorder 20.

2. Camera Registration Processing

In the camera registration processing, registration processing of a connection position of the camera 10 is also performed in addition to the processing of the first exemplary embodiment. The camera search command response includes the information in FIG. 7, and further includes the MAC address and model name of the camera 10.

In a case where the camera information setting unit 250 sets the IP address to the camera 10 as in the first exemplary embodiment, the switching hub search unit 270 transmits a switching hub search command to the plurality of switching hubs 40. Upon receiving the switching hub search command, each of the switching hubs 40 transmits a connection position information table to the recorder 20. The switching hub information acquisition unit 272 acquires the connection position information table from each of the switching hubs 40. The connection position information table acquired by the initial setting processing described above may be stored in the storage 26. In this case, there is no need to newly acquire the connection position information table.

The camera information setting unit 250 specifies the connection position of the camera 10 on the basis of the acquired connection position information table and the MAC address of the camera 10 to which the IP address has been set. Specifically, the camera information setting unit 250 specifies the port with which solely the MAC address of the camera 10 is associated and the switching hub ID of the connection position information table including the port, as the connection position.

The system information holding unit 260 registers, as information of the camera 10 to which the IP address has been set, the camera ID and the IP address of the camera 10, and further registers the connection position of the camera 10, the MAC address of the camera 10, and the model name of the camera 10, onto the system information table. Moreover, the system information holding unit 260 also registers the operation setting information of the camera 10 to which the IP address has been set, in association with the camera ID of the camera 10. The operation setting information of the camera 10 may be included in the camera search command response transmitted from the camera 10 or may be input by the user into the recorder 20.

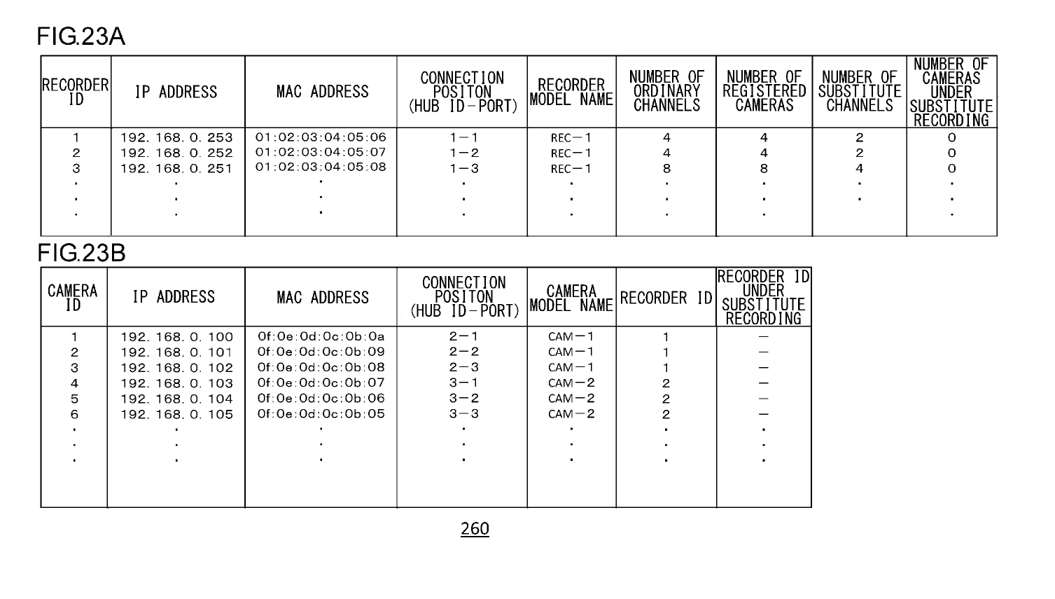

FIGS. 23A and 23B are diagrams each illustrating a data structure of the system information table stored in the system information holding unit 260 in FIG. 21. FIG. 23A illustrates combinations of a plurality of recorder IDs, and the IP addresses, the MAC addresses, the connection positions, model name of the recorder, the number of ordinary channels, the number of registered cameras, the number of substitute channels, and the number of cameras under substitute recording, associated with each of the recorder IDs. FIG. 23B illustrates the camera ID, the IP address, the MAC address, the model name of the camera, and the connection positions, of the camera 10, the recorder ID of the recorder 20 that has registered the camera 10 using the ordinary channel, and the recorder ID under substitute recording toward the camera 10. The recorder ID and the IP address of the recorder 20, the camera ID of the camera 10 registered to the recorder 20, and the operation setting information of the recorder 20 can also be referred to as setting information of the recorder 20 associated with the connection position. The camera ID, the IP address, and the operation setting information of the camera 10 can also be referred to as setting information of the camera 10 associated with the connection position.

The connection position, or the like, of each of the cameras 10 registered in the system information table is used for camera replacement processing described below, while the connection position, or the like, of each of the recorders 20 is used for the recorder recovery processing described below.

3. Ordinary State Processing

In the ordinary state processing, the following processing is also performed in addition to the processing of the first exemplary embodiment. The camera search unit 246 periodically transmits a camera search command to search for the plurality of cameras 10. The camera information acquisition unit 248 receives the camera search command response from the plurality of cameras 10. By receiving the camera search command response from the plurality of cameras 10 to which the camera search command has been transmitted, the recorder 20 confirms that the plurality of cameras 10 is in the normal state.

As described in the first exemplary embodiment, each of the recorders 20 periodically transmits a recorder search command to the other recorder 20, updates the system information table to the latest information on the basis of the received recorder search command response. Accordingly, each of the recorders 20 holds the system information table in FIGS. 23A and 23B.

4. Camera Replacement Processing

In a case where the camera search unit 246 transmits a camera search command and the camera information acquisition unit 248 has not received a camera search command response with a certain camera ID, the camera information setting unit 250 determines that the camera 10 having the same camera ID is in an abnormal state. In the following, the processing in a case where the camera 10 shifts to an abnormal state and the camera 10 being in the abnormal state is replaced with a new camera 10 will be described. The following processing is executed by one predetermined recorder 20, for example, the first recorder 20a. In a case where the first recorder 20a cannot execute the following processing, any one of the other recorders 20 may execute the following processing.

Here, it is assumed that the camera 10 having the camera ID 2 has failed. The camera information setting unit 250 recognizes that the camera 10 having the camera ID 2 has failed from the camera search command response periodically acquired. The camera information setting unit 250 specifies from the system information table that the connection position of the failed camera 10 having the camera ID 2 is “2-2”, that is, the port 2 of the switching hub ID 2.

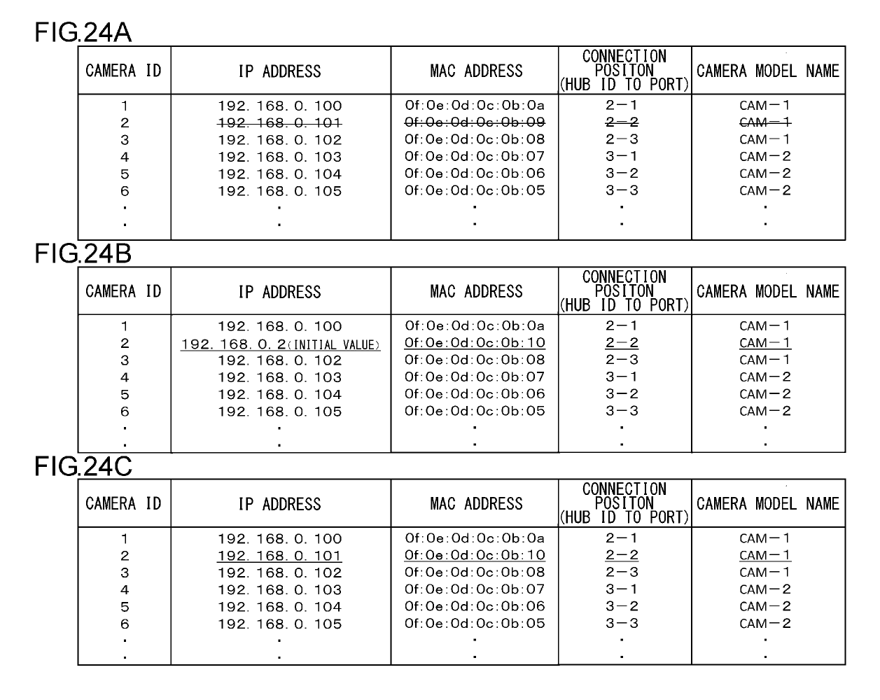

FIG. 24A is a diagram illustrating a data structure of a portion of the system information table in a case where the camera 10 having the camera ID 2 failed, according to the third exemplary embodiment. The occurrence of the failure of the camera 10 having the camera ID 2 disables acquiring of each piece of information of the camera ID 2.

In a case where there is a camera 10 that has failed, the switching hub information acquisition unit 272 periodically confirms the MAC address of the connection position of the camera 10 that has failed. Specifically, the switching hub search unit 270 periodically transmits a switching hub search command to the switching hub 40. The switching hub information acquisition unit 272 periodically acquires the connection position information table from the switching hub 40 and confirms the MAC address of the connection position “2-2”. That is, the switching hub information acquisition unit 272 acquires the connection position information indicating the connection position of the camera 10 on the network NW1, together with the MAC address of the camera 10. This switching hub information acquisition unit 272 can be considered to be a connection position information acquisition unit in the recorder 20.

When the camera 10 in the abnormal state is removed by the user and the new camera 10 is connected to the port 2 of the second switching hub 40b, the second switching hub 40b acquires the MAC address of the new camera 10 and updates the connection position information table. Accordingly, the switching hub information acquisition unit 272 detects a new MAC address at the connection position “2-2” from the acquired connection position information table.

In a case where the new MAC address is detected at the connection position “2-2”, that is, in a case where the MAC address of the connection position “2-2” has been changed, the camera search unit 246 broadcasts a camera search command onto the network NW1 and searches for the plurality of cameras 10. The camera information acquisition unit 248 receives the camera search command response from the plurality of cameras 10. The camera information acquisition unit 248 analyzes the camera search command response and acquires the model name, or the like, of the new camera 10 at the connection position “2-2”.

FIG. 24B is a diagram illustrating a data structure of a portion of the system information table in which the MAC address of the camera ID 2 has been changed. The MAC address of the camera ID 2 has been changed, resulting in the change in the IP address to the initial value.

The camera information setting unit 250 confirms whether the model name of the new camera 10 acquired by the camera information acquisition unit 248 is the same as the model name of the failed camera 10 having the camera ID 2 in the old system information table. In a case where the new camera 10 is the same model as the failed camera 10, the camera information setting unit 250 applies the setting information of the failed camera 10 to the new camera 10. Specifically, the camera information setting unit 250 transmits a command for setting the camera ID 2, the IP address “192.168.0.101” of the failed camera 10, and operation setting such as encoding setting of the failed camera 10, to the new MAC address “0f:0e:0d:0c:0b:10”. This sets the camera ID, the IP address, and the operation setting to the new camera 10. Moreover, the camera information setting unit 250 registers the new MAC address of the new camera 10 onto the system information table in association with the camera ID 2. That is, the MAC address of the camera ID 2 is changed, and the other information is maintained, in comparison to the system information table before the failure of the camera 10. In this manner, in a case where the MAC address at a connection position of the camera 10 being in the abnormal state has been changed, the camera information setting unit 250 sets the camera 10 having the new MAC address using the setting information associated with the connection position, on the basis of the connection position information and the MAC address acquired by the switching hub information acquisition unit 272.

FIG. 24C is a diagram illustrating a data structure of a portion of the system information table in which the IP address of the camera ID 2 is set. The IP address of the camera ID 2 has been changed to the IP address of the failed camera 10.

Meanwhile, in a case where the new camera 10 having the new MAC address is not the same model as the failed camera 10, the camera information setting unit 250 finishes the processing. This is because in a case where the setting of the failed camera 10 is applied to the new camera 10 with a different model, there is a possibility that recording cannot be performed appropriately. In this case, the user performs the setting of the new camera 10.

5. Recorder Abnormal State Processing

Since the recorder abnormal state processing is performed in a manner similar to the abnormal state processing of the first exemplary embodiment, the description thereof will be omitted. Here again, a case where the recorder 20 fails is assumed as the abnormal state.

6. Recorder Recovery Processing

The recorder recovery processing is executed by the normal recorder 20, for example, the first recorder 20a. The recorder information setting unit 244 of the first recorder 20a specifies from the system information table that the connection position of the failed recorder 20 having the recorder ID 2 is “1-2”, that is, the port 2 of the switching hub ID 1.

In a case where there is a failed recorder 20, the switching hub information acquisition unit 272 periodically confirms the MAC address of the connection position of the failed recorder 20. Specifically, the switching hub search unit 270 periodically transmits a switching hub search command to the switching hub 40. The switching hub information acquisition unit 272 periodically acquires the connection position information table from the switching hub 40 and confirms the MAC address of the connection position “1-2”. That is, the switching hub information acquisition unit 272 acquires the connection position information indicating the connection position of the other recorder 20 on the network NW1, together with the MAC address of the other recorder 20.

When the recorder 20 in the abnormal state is removed by the user and the new recorder 20 is connected to the port 2 of the first switching hub 40a, the first switching hub 40a acquires the MAC address of the new recorder 20 and updates the connection position information table. Accordingly, the switching hub information acquisition unit 272 detects a new MAC address at the connection position “1-2” from the acquired connection position information table.

In a case where the new MAC address is detected at the connection position “1-2”, that is, in a case where the MAC address of the connection position “1-2” has been changed, the recorder search unit 240 broadcasts a recorder search command including the recorder ID 2 onto the network NW1 and searches for the new recorder 20 having the recorder ID 2. The recorder information acquisition unit 242 receives the recorder search command response from the new recorder 20 having the recorder ID 2. The recorder information acquisition unit 242 analyzes the recorder search command response and acquires the model name, or the like, of the new recorder 20 at the connection position “1-2”.

The recorder information setting unit 244 confirms whether the model name of the new recorder 20 acquired by the recorder information acquisition unit 242 is the same as the model name of the failed recorder 20 having the recorder ID 2 in the old system information table. In a case where the new recorder 20 is the same model as the failed recorder 20, the recorder information setting unit 244 applies the setting information of the failed recorder 20 to the new recorder 20. Specifically, the recorder information setting unit 244 transmits, to the new MAC address, a command for setting the recorder ID 2, the IP address “192.168.0.252” of the failed recorder 20, the camera IDs of all the cameras 10 registered by the failed recorder 20, and the operation setting of the failed recorder 20. This operation sets the recorder ID, the IP address, and the operation setting to the new recorder 20, and causes the camera 10 registered by the failed recorder 20 to be registered to the new recorder 20. Moreover, the recorder information setting unit 244 registers the new MAC address of the new recorder 20 onto the system information table in association with the recorder ID 2. That is, the MAC address having the recorder ID 2 is changed and the other information is maintained, in comparison with the system information table before the recorder 20 fails. In this manner, in a case where the MAC address at a connection position of the recorder 20 being in the abnormal state has been changed, the recorder information setting unit 244 sets the recorder 20 having the new MAC address using the setting information associated with the connection position, on the basis of the connection position information and the MAC address acquired by the switching hub information acquisition unit 272.

In contrast, in a case where the new recorder 20 is not the same model as the failed recorder 20, the recorder information setting unit 244 finishes the processing. This is because in a case where the setting of the failed recorder 20 is applied to the new recorder 20 with a different model, there is a possibility that recording cannot be performed appropriately. In this case, the user performs the setting of the new recorder 20.

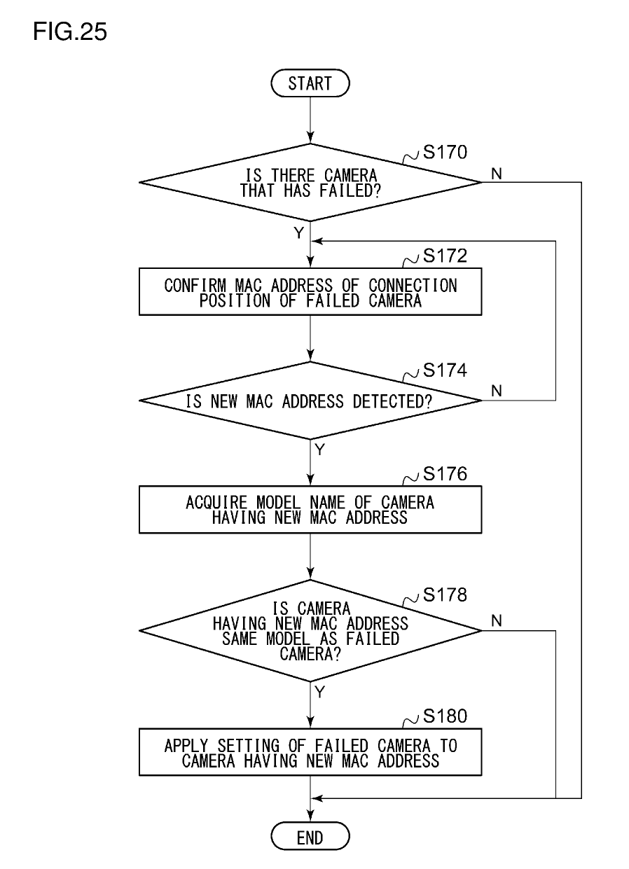

Operation of the network camera system 100 with the above configuration will be described. FIG. 25 is a flowchart illustrating setting processing of the new camera 10 by the recorder 20. The processing in FIG. 25 is periodically performed. In a case where there is no camera 10 that has failed (N in S170), the processing ends. In a case where there is the camera 10 that has failed (Y in S170), the switching hub information acquisition unit 272 confirms the MAC address of the connection position of the failed camera 10 (S172). In a case where the new MAC address is not detected (N in S174), the processing returns to step 172. In a case where the new MAC address is detected (Y in S174), the camera information acquisition unit 248 acquires the model name of the camera 10 having the new MAC address (S176), and in a case where the camera 10 having the new MAC address is not the same model as the failed camera 10 (N in S178), the processing ends. In a case where the camera 10 having the new MAC address is the same model as the failed camera 10 (Y in S178), the camera information setting unit 250 applies the setting of the failed camera 10 to the camera 10 having the new MAC address (S180), and the processing ends.

According to the present exemplary embodiment, in a case where the MAC address at the connection position of the camera 10 being in the abnormal state is changed, the camera 10 having the new MAC address is set using the setting information associated with the connection position, making it possible to apply the setting of the failed camera 10 to the new camera 10 merely by replacing the failed camera 10 with the new camera 10. Accordingly, even in a case where the camera 10 fails, the user can restore the network camera system 100 without setting the camera 10.

This also makes it possible to reduce the man-hours on the user in replacement of the camera 10 and to suppress erroneous setting by the user. Moreover, even in a case where a plurality of cameras 10 fails, there is no need to distinguishably manage each of the plurality of cameras 10, leading to enhanced convenience.

Moreover, in a case where the MAC address at the connection position of the recorder 20 being in the abnormal state is changed, the recorder 20 having the new MAC address is set using the setting information associated with the connection position, making it possible to apply the setting of the failed recorder 20 to the new recorder 20 by merely replacing the failed recorder 20 with the new recorder 20. Therefore, even in a case where the recorder 20 fails, the user can restore the network camera system 100 without setting the recorder 20. Moreover, it is possible to register the original camera 10 in a case where the recorder 20 has been replaced with the new recorder 20. Moreover, since the original camera 10 is registered in a case where the recorder 20 has been replaced with the new recorder 20, it is possible to restore the state before the occurrence of the abnormal state.

The present invention has been described with reference to the exemplary embodiments. The above-described exemplary embodiment has been described merely for exemplary purposes. Rather, it can be readily conceived by those skilled in the art that various modification examples may be made by making various combinations of the above-described components or processes, which are also encompassed in the technical scope of the present invention.

In the above description, the camera 10 and the recorder 20 are connected in the network camera system 100 and the analog camera system 200. The present invention, however, is not limited to this, and it is allowable to use a printer, a facsimile machine, or the like, instead of the camera 10, and use a personal computer instead of the recorder 20. With this modification, the degree of freedom of configuration can be enhanced.

Moreover, in the third exemplary embodiment, the recorder recovery processing may be performed without using the connection position information in a similar manner to the recovery processing of the first exemplary embodiment.

What is claimed is:

1. A registration apparatus connectable to a network, the apparatus comprising:
an acquisition unit that acquires state information of another registration apparatus connected to the network; and
a registration unit that registers an unregistered registration target apparatus within a range of the settable number of ordinary channels, on the basis of the state information acquired by the acquisition unit,
wherein in a case where the other registration apparatus is in an abnormal state, the registration unit substitutively registers a registration target apparatus registered to the other registration apparatus being in an abnormal state, even in a range of the number of substitute channels other than the ordinary channels.

2. The registration apparatus according to claim 1, further comprising:
a notification unit that provides notification of state information including identification information related to the registration target apparatus registered on the registration unit,
wherein in a case where the registration unit has substitutively registered the registration target apparatus registered to the other registration apparatus being in an abnormal state, the notification unit provides notification of identification information related to the other registration apparatus being in an abnormal state so as to be included in the state information.

3. The registration apparatus according to claim 1,
wherein in a case where the identification information of the registration apparatus is included in the state information acquired by the acquisition unit, the registration unit registers the registration target apparatus associated with the identification information within a range of the settable number of ordinary channels.

4. The registration apparatus according to claim 1, further comprising:
a connection position information acquisition unit that acquires connection position information indicating a connection position of the other registration apparatus on the network, together with unique information unique to the other registration apparatus; and
a setting unit that sets the other registration apparatus having new unique information using setting information associated with the connection position, in a case where the unique information at the connection position of the other registration apparatus being in an abnormal state has been changed, on the basis of the connection position information and the unique information acquired by the connection position information acquisition unit.

5. The registration apparatus according to claim 1, further comprising:
a connection position information acquisition unit that acquires connection position information indicating a connection position of the registration target apparatus on the network, together with unique information unique to the registration target apparatus,
wherein in a case where the unique information at the connection position of the registration target apparatus being in an abnormal state has been changed, the registration unit sets the registration target apparatus having new unique information using setting information associated with the connection position, on the basis of the connection position information and the unique information acquired by the connection position information acquisition unit.

6. A registration apparatus connectable to a network, the apparatus comprising:
a registration unit that registers a registration target apparatus connected to the network; and
a connection position information acquisition unit that acquires connection position information indicating a connection position of the registration target apparatus on the network, together with unique information unique to the registration target apparatus,
wherein in a case where the unique information at the connection position of the registration target apparatus being in an abnormal state has been changed, the registration unit sets the registration target apparatus having new unique information using setting information associated with the connection position, on the basis of the connection position information and the unique information acquired by the connection position information acquisition unit.

7. A registration method in a registration apparatus connectable to a network, the method comprising:
acquiring state information of another registration apparatus connected to the network;
registering an unregistered registration target apparatus within a range of the settable number of ordinary channels, on the basis of the acquired state information; and
in a case where the other registration apparatus is in an abnormal state, substitutively registering a registration target apparatus registered to the other registration apparatus being in an abnormal state, even in a range of the number of substitute channels other than the ordinary channels.
